(19) United States
(12) Patent Application Publication
(10) Pub. No.: US 2025/0306490 A1
(43) Pub. Date: Oct. 2, 2025

(54) TONER

(71) Applicant: CANON KABUSHIKI KAISHA, Tokyo (JP)

(72) Inventors: SHOHEI TSUDA, Shizuoka (JP); TORU ISHII, Shizuoka (JP); KOSUKE FUKUDOME, Tokyo (JP); KAZUYUKI SATO, Kanagawa (JP); KENYA TERADA, Shizuoka (JP)

(21) Appl. No.: 19/087,194

(22) Filed: Mar. 21, 2025

(30) Foreign Application Priority Data
Mar. 26, 2024 (JP) 2024-049553
Mar. 4, 2025 (JP) 2025-033698

(51) Int. Cl. G03G 9/087; G03G 9/08; G03G 9/097

(52) U.S. Cl. CPC G03G 9/08755; G03G 9/0827; G03G 9/09708

(57) ABSTRACT

Toner includes toner particles containing a binder resin and an external additive, wherein 1) the binder resin contains a polyester A in an amount of 50% by mass or more, and the polyester A contains a unit Uᵢₛₒ derived from isophthalic acid in an amount of 90% by mole or more based on all units derived from an acid component, and 2) the toner contains hydrotalcite particles as the external additive.

### BACKGROUND

### Technical Field

The present disclosure relates to a toner for use in an electrophotographic image-forming apparatus.

### Description of the Related Art

In recent years, improvements have been made in electrophotographic image-forming apparatuses for higher speed, smaller size, and higher environmental stability. For example, although a one-component contact development system is suitably used for miniaturization from the perspective of reducing the number of components, since a developing member bearing a toner is in contact with a photosensitive member for an extended period, a highly durable toner that is resistant to toner deterioration is required. Furthermore, to shorten the time of a fixing process and reduce the size of a fixing member, a toner that can be fixed to paper with a small amount of heat is required. Furthermore, to achieve a reduction in the time of a charging process and a reduction in the diameter of a charging member, toner is required to have high chargeability so as to be immediately chargeable. Furthermore, there is a demand for a toner that has stable chargeability and does not cause a change in an output image even when there is a large change in the operating environment, such as low temperature and low humidity or high temperature and high humidity.

Thus, to increase the speed, reduce the size, and improve the environmental stability, there is an increasing demand for maintaining the low-temperature fixability and the high charging stability of toner even after long-term use in any operating environment as compared with the related art. However, in general, a toner with good low-temperature fixability tends to have low durability, and achieving both of good low-temperature fixability and high durability was sometimes a challenge.

Japanese Patent Laid-Open No. 2019-049629 proposes that the offset property of a solid image to another image can be improved by controlling the state of a release agent present in toner particles and the dynamic viscoelasticity of the toner particles and further controlling the amount of isophthalic acid with respect to the entire polycarboxylic acid of a polyester serving as a binder resin.

On the other hand, for example, Japanese Patent Laid-Open No. 2009-251151 describes that a toner containing a polyester with a urea bond or a urethane bond and containing, as an external additive, a layered double hydroxide containing an Mg element and an Al element has fast charge build-up and can maintain charging performance for an extended period.

Furthermore, Japanese Patent Laid-Open No. 2009-181099 proposes to contain a polyester with an isophthalic acid unit as a very small part of a binder resin and also contain hydrotalcite particles.

As a result of studies conducted by the present inventors, there is still room for improvement in achieving both stable maintenance of charging performance and low-temperature fixability over long-term use in the case where a change in the temperature and humidity of the operating environment occurs in a copying machine or a printer that is becoming faster and smaller. More specifically, in the toner described in Japanese Patent Laid-Open No. 2019-049629, a toner containing a polyester with a unit derived from isophthalic acid as a binder resin was used for a certain improvement effect on the low-temperature fixability. In an image-forming apparatus including a one-component development system, however, when the operating environment is changed from a normal temperature and humidity environment to a low-temperature and low-humidity environment, overcharging sometimes increases the electrostatic aggregation tendency of the toner, broadens the charge distribution, and impairs the adaptability of a solid image. This sometimes results in density unevenness toward the rear end of the solid image. The toner described in Japanese Patent Laid-Open No. 2009-251151 is certainly confirmed to have a fast rising of charging of the toner in a high-temperature and high-humidity environment and a certain effect on long-term stability, but there is room for improvement in the case where the operating environment is changed to a low-temperature and low-humidity environment. There is also room for improvement in the low-temperature fixability of the toner. The toner described in Japanese Patent Laid-Open No. 2009-181099 contains a polyester with a unit derived from isophthalic acid, but the improvement of the low-temperature fixability is insufficient. Furthermore, in an image-forming apparatus including a one-component development system, when the operating environment is changed from a normal temperature and humidity environment to a low-temperature and low-humidity environment, overcharging sometimes increases the electrostatic aggregation of the toner, broadens the charge distribution, and impairs the adaptability of a solid image.

### SUMMARY

The present disclosure provides a toner without such disadvantages. More specifically, the present disclosure provides a toner that has low-temperature fixability, has less electrostatic aggregation even when the environment is changed from a normal temperature and humidity environment to a low-temperature and low-humidity environment during use, has a sharp charge distribution, has high adaptability of a solid image, and has less density unevenness.

To solve the above disadvantages, the present inventors have conducted extensive studies on the low-temperature fixability and the electrostatic aggregation tendency of toner.

As a result, the present inventors have found that when toner particles contain at least a specific amount of polyester A containing at least a certain amount of unit derived from isophthalic acid and have hydrotalcite particles as an external additive, both the low-temperature fixability and less electrostatic aggregation can be achieved for the first time even in the case of a change in the operating environment, more specifically, a change from a normal temperature and humidity environment to a low-temperature and low-humidity environment.

That is, the present disclosure relates to a toner that contains toner particles containing a binder resin and an external additive, wherein
1) the binder resin contains a polyester A in an amount of 50% by mass or more, and the polyester A contains a unit Uᵢₛₒ derived from isophthalic acid in an amount of 90% by mole or more based on all units derived from an acid component, and
2) the toner contains hydrotalcite particles as the external additive.

Further features of the present disclosure will become apparent from the following description of exemplary embodiments with reference to the attached drawing.

### BRIEF DESCRIPTION OF THE DRAWINGS

FIGS. 1A to 1C are schematic views of energy dispersive spectroscopy (EDS) line analysis in scanning transmission electron microscope-energy dispersive spectroscopy (STEM-EDS) mapping analysis.

### DESCRIPTION OF THE EMBODIMENTS

As described above, as a means for improving the low-temperature fixability of toner, it is effective to incorporate a polyester containing a large amount of unit derived from isophthalic acid into toner particles as a main component of a binder resin.

In an image-forming apparatus employing a one-component contact development system, however, when the environment is changed from a normal temperature and humidity environment to a low-temperature and low-humidity environment during use, electric charges accumulated in toner are less liable to be released, so that the electric charges of the toner are easily localized, and the toner tends to be overcharged and cause electrostatic aggregation. It was found that this results in lower flowability, a solid image with lower adaptability, and image-density irregularities.

Furthermore, as described above, since toner is in contact with a photosensitive member for an extended period, the one-component contact development system is very severe with respect to toner deterioration, and in a low-temperature and low-humidity environment in which each member becomes hard, frictional sliding force applied to the toner is strong, and non-electrostatic adhesion force is further increased. In addition, studies conducted by the present inventors showed that, particularly in a low-temperature and low-humidity environment, friction of toner between a hardened photosensitive member and a developing roller promotes charging and tends to cause overcharging.

Thus, in the image-forming apparatus employing the one-component contact development system, when the environment is changed from a normal temperature and humidity environment to a low-temperature and low-humidity environment during use, it was found that overcharging further increases the electrostatic aggregation tendency, impairs the adaptability of a solid image, and causes a change in an output image, such as density unevenness.

Detailed studies by the present inventors showed that toner particles that contain a polyester containing a unit derived from isophthalic acid and contain hydrotalcite as an external additive can significantly suppress overcharging and suppress electrostatic aggregation of the toner as compared with toner particles that contain a polyester containing only a unit derived from terephthalic acid.

The reason for this is not clear but is considered as described below.

Hydrotalcite is a layered double hydroxide and can intercalate and retain water molecules. Isophthalic acid is an aromatic dicarboxylic acid with two carboxylic acids at the meta positions of the benzene ring, and in the unit derived from isophthalic acid the orientations of the oxygen atoms of the carbonyl groups bonded to the benzene ring are easily aligned. Thus, it microscopically has a region with a large amount of electric charge, and charge imbalance is likely to occur in the molecular chain. The hydrotalcite and the binder resin containing the unit derived from isophthalic acid with such characteristics are combined. In doing so, when a printer is transferred from a normal temperature and humidity environment to a low-temperature and low-humidity environment, water retained in the hydrotalcite can be rapidly and uniformly transferred from the inside of the molecule and the entire terminal of the binder resin with charge imbalance to instantaneously release electric charges. This is considered to reduce the electrostatic aggregation, improve the solid adaptability, and suppress the density unevenness.

On the other hand, terephthalic acid is an aromatic dicarboxylic acid with two carboxylic acids at the para positions of the benzene ring and is therefore unlikely to cause charge imbalance in the molecular chain. Thus, water retained in the hydrotalcite cannot be transferred to the inside of the molecule and the entire terminal of the binder resin, resulting in overcharging, and electrostatic aggregation of the toner cannot be suppressed. This results in lower solid adaptability, density unevenness, and a change in the image quality of an output image depending on the environment.

Thus, the present disclosure is achieved by a toner that contains toner particles containing a binder resin and an external additive, wherein
1) the binder resin contains a polyester A in an amount of 50% by mass or more, and the polyester A contains a unit Uᵢₛₒ derived from isophthalic acid in an amount of 90% by mole or more based on all units derived from an acid component, and
2) the toner contains hydrotalcite particles as the external additive.

A toner according to the present disclosure contains toner particles containing a binder resin.

It is required that the binder resin contains a polyester A in an amount of 50% by mass or more, and the polyester A contains a unit Uᵢₛₒ derived from isophthalic acid in an amount of 90% by mole or more based on all units derived from acid components (Uᵢₛₒ/all acid components×100 is 90% by mole or more). This improves not only the fixability of a solid image in a low-temperature and low-humidity environment but also the adaptability of a solid image even when a one-component contact development system is transferred from a normal temperature and humidity environment to a low-temperature and low-humidity environment, thus suppressing image-density irregularities. Less than 90% by mole results in insufficient charge imbalance in the molecular chain of the binder resin to instantaneously release electric charges and results in a solid image with low adaptability. Uᵢₛₒ/all acid components×100 is preferably 95% by mole or more.

The polyester A can contain a unit U_{EO} derived from an ethylene oxide adduct of bisphenol A and a unit U_{PO} derived from a propylene oxide adduct of bisphenol A. Furthermore, the total unit U_{EO} and unit U_{PO} content is preferably 90% by mole or more based on all units derived from an alcohol component. The ethylene oxide adduct of bisphenol A and the propylene oxide adduct of bisphenol A have a characteristic of being easily plasticized by wax, a crystalline polyester, or the like contained in toner particles when heated and melted at the time of fixing. Thus, when the content is in the above range, the binder resin is plasticized when heated and melted at the time of fixing and easily permeates into paper fibers. This can further enhance the adhesiveness of the toner to paper and improve the fixability of a solid image on not only plain paper but also rough paper.

The ratio U_{EO}/(U_{EO}+U_{PO})×100 of the unit U_{EO} content to the sum of the unit U_{EO} content and the unit U_{PO} content is preferably 15% by mole or more and 40% by mole or less.

U_{PO} has a larger number of carbon atoms than U_{EO} and is a bisphenol A unit to which propylene oxide with a branched structure is added. Thus, the U_{PO} unit has higher hydrophobicity and lower intermolecular force than the U_{EO} unit. Conversely, the U_{EO} unit has lower hydrophobicity and higher intermolecular force than the U_{PO} unit.

When U_{EO}/(U_{EO}+U_{PO})×100 is 15% by mole or more, the polyester A has higher intermolecular force and is less likely to be deformed. On the other hand, when U_{EO}/(U_{EO}+U_{PO})×100 is 40% by mole or less, the polyester A has higher hydrophobicity and does not have an excessively high water adsorption amount in a high-temperature and high-humidity environment. Due to these effects, U_{EO}/(U_{EO}+U_{PO})×100 is preferably 15% by mole or more and 40% by mole or less in terms of high toner durability and, in particular, less fogging in a non-image area after being left to stand in a high-temperature and high-humidity environment.

The tetrahydrofuran (THF) soluble matter of the polyester A preferably has a number-average molecular weight (Mn) of 3,000 or more and 10,000 or less and a ratio (Mw/Mn) of 2.5 or more when the number-average molecular weight (Mn) and a weight-average molecular weight (Mw) are measured by gel permeation chromatography (GPC).

The number-average molecular weight (Mn) is preferably 3,000 or more in terms of improved toner durability and less fogging in a non-image area. On the other hand, the number-average molecular weight (Mn) is preferably 10,000 or less because the binder resin has higher melt flowability at the time of fixing, easily permeates into paper fibers, has higher adhesiveness to paper, and has higher fixability on not only plain paper but also rough paper. More preferably, the number-average molecular weight (Mn) is 3,500 or more and 8,000 or less.

(Mw/Mn) of 2.5 or more means that the polyester A has a sufficiently wide molecular weight distribution. As a result, the molecular chains of the polyester A are sufficiently entangled with each other, so that the toner particles have sufficient hardness, the toner has improved durability, and fogging in a non-image area can be suppressed.

The binder resin can further contain a crystalline polyester because the toner has good low-temperature fixability. A polyester suitable for the crystalline polyester is described later.

The toner particles preferably contain an aluminum element in an amount of 0.015% by mass or more and 0.150% by mass or less in terms of higher solid adaptability and dot reproducibility in a low-temperature and low-humidity environment. Although the reason is not clear, when the amount of aluminum element is in the above range, the affinity for hydrotalcite containing Al as an element is improved. It is surmised that this improves the fixing property and the uniform adhesiveness of hydrotalcite particles to the toner particles, enables efficient water transfer, and improves the solid adaptability and the dot reproducibility due to appropriate non-electrostatic adhesion force among the toner particles. An aluminum source can be used as an internal additive or an aggregating agent to contain an aluminum element in the toner particles. In particular, an aluminum source can be added as an aggregating agent from the perspective that the aluminum element can be contained in the toner particles through a state of being ionized in an aqueous medium to achieve uniformity.

In the toner, from the perspective of easily producing the above effects, the relationship h/d between the hydrotalcite particle content h (%) on a mass basis described later and the aluminum element content d (%) of the toner particles on a mass basis is preferably 2.0 or more and 20.0 or less.

The toner needs to have hydrotalcite particles as an external additive.

The hydrotalcite particles are typically represented by the following structural formula (2):

M²⁺_{y}M³⁺ₓ(OH)₂Aⁿ⁻_{(x/n)}·mH₂O formula (2)

wherein 0<x≤0.5, y=1−x, m≥0, M²⁺ and M³⁺ denote a divalent metal and a trivalent metal, respectively. M²⁺ can be at least one divalent metal ion selected from the group consisting of Mg, Zn, Ca, Ba, Ni, Sr, Cu, and Fe. M³⁺ can be at least one trivalent metal ion selected from the group consisting of Al, B, Ga, Fe, Co, and In.

Aⁿ⁻ denotes an n-valent anion, such as CO₃²⁻, OH⁻, Cl⁻, I⁻, F⁻, Br⁻, SO₄²⁻, HCO₃⁻, CH₃COO⁻, or NO₃⁻, alone or in combination. The hydrotalcite particles can contain at least Al as M³⁺ and at least Mg as M²⁺. Furthermore, at least F is contained as Aⁿ⁻. Thus, the hydrotalcite particles can contain magnesium and aluminum.

The hydrotalcite particles can contain fluorine. Fluorine in the hydrotalcite particles suppresses the positive chargeability of the hydrotalcite particles and further suppresses the electrostatic aggregation between the hydrotalcite particles. This allows uniform adhesion to the toner particles and easily suppresses local electrostatic aggregation of the toner. Furthermore, the presence of fluorine in the hydrotalcite on the toner particle surface increases releasability, reduces adhesiveness to a fixing film, and therefore improves adhesiveness to paper. This can improve the low-temperature fixability.

More specifically, the hydrotalcite particles are, for example, Mg_{4.3}Al₂(OH)_{12.6}CO₃·mH₂O, Mg_{8.6}Al₄(OH)_{25.2}F₂CO₃·mH₂O, Mg₁₂Al₄(OH)₃₂F₂CO₃·mH₂O, or the like.

The hydrotalcite particles may be a solid solution containing a plurality of different elements. Furthermore, a trace amount of a monovalent metal may be contained.

The atomic number concentration ratio Mg/Al (element ratio) of magnesium to aluminum in the hydrotalcite particles determined from the principal component mapping of the hydrotalcite particles by STEM-EDS mapping analysis of the toner is preferably 1.5 or more and 4.0 or less from the perspective of chargeability. It is more preferably 1.6 or more and 3.8 or less, still more preferably 2.1 or more and 3.8 or less.

Mg/Al can be controlled by adjusting the amount of raw materials at the time of production of hydrotalcite.

In line analysis in the STEM-EDS mapping analysis of the toner, fluorine and aluminum can be present within the hydrotalcite particles containing fluorine. It can therefore be confirmed that fluorine is intercalated between layers of the layered structure of the hydrotalcite particles.

The element ratio F/Al of fluorine to aluminum in the hydrotalcite particles is preferably 0.01 or more and 0.60 or less, more preferably 0.02 or more and 0.50 or less. When F/Al is 0.01 or more, electrostatic aggregation of the hydrotalcite particles can be suppressed, and the hydrotalcite is likely to be uniformly attached to the toner particles. This also easily improves the releasability between a fixing film and the toner and easily improves the low-temperature fixability. When F/Al is 0.60 or less, both water retention and the suppression of the positive chargeability of the hydrotalcite particles are easily achieved, and as a result, in a low-temperature and low-humidity environment, the local electrostatic aggregation of the toner is easily suppressed, and the solid adaptability is easily improved. In a high-temperature and high-humidity environment, it is easy to suppress the deterioration of fogging due to being left to stand.

From the perspective of the above mechanism, the hydrotalcite particles more preferably satisfy 0.1<m<0.6 in the formula (2).

The hydrotalcite particles preferably have a number-average particle diameter of 50 nm or more and 1200 nm or less, more preferably 60 nm or more and 1000 nm or less, still more preferably 100 nm or more and 800 nm or less. When the particle size is 50 nm or more, the water retention effect can be maintained without being embedded in the toner particles through long-term use. When the particle size is 1200 nm or less, the toner flowability is easily maintained, and the electrostatic aggregation is less likely to occur.

The hydrotalcite particles may be subjected to hydrophobization treatment with a surface treatment agent. The surface treatment agent may be a higher fatty acid, a coupling agent, an ester, or an oil, such as silicone oil. In particular, a higher fatty acid can be used, and specific examples thereof include stearic acid, oleic acid, and lauric acid.

The hydrotalcite particle content h (%) of the toner is preferably 0.01% or more and 3.00% or less, more preferably 0.05% or more and 0.50% or less, on a mass basis. The hydrotalcite particle content can be quantified by x-ray fluorescence analysis using a calibration curve prepared from a standard sample. The content can be controlled by changing the amount of the hydrotalcite particles added to the toner particles.

The relationship h/a between the polyester A content a (%) of the binder resin on a mass basis and the hydrotalcite particle content h (%) of the toner on a mass basis is preferably 0.001 or more and 0.006 or less. Controlling in this range makes it easy to stably maintain a low electrostatic aggregation tendency over long-term use.

The toner preferably has an average circularity of 0.950 or more and 0.980 or less in terms of high developability and a good image even in long-term durable use. More specifically, when the average circularity is 0.950 or more, uniform adhesiveness of the hydrotalcite particles to the toner particles is secured, and high flowability is easily obtained. Thus, even in long-term use in a low-temperature and low-humidity environment, this can suppress development stripes formed by adhesion of the toner to a developing blade or the like.

On the other hand, an average circularity of 0.980 or less results in an appropriate non-electrostatic adhesion force between toner particles in a low-temperature and low-humidity environment in which the non-electrostatic adhesion force between toner particles tends to decrease. This can suppress scattering of the toner in a transferring step and improve the dot reproducibility. The toner more preferably has an average circularity of 0.955 or more and 0.975 or less.

To adjust the circularity of toner to a preferred range, the method for producing toner can be a method for producing a chemical toner, such as an emulsion aggregation method, a suspension polymerization method, or a suspension granulation method.

When the emulsion aggregation method is used, to provide the toner with a desired surface profile, a spheronization step can be provided to adjust the circularity.

When a pulverization method is used, the circularity of toner can be adjusted by a thermal spheronization treatment as a surface treatment with hot air.

Some constituents and aspects of a toner according to the present disclosure are described below.

### Binder Resin

The toner particles contain a binder resin. The binder resin content is preferably 50% by mass or more of the total amount of resin components in the toner particles.

As described above, the binder resin needs to contain the polyester A in an amount of 50% by mass or more, and when the amount is 70% by mass or more, both the low-temperature fixability and the reduction of electrostatic aggregation can be easily achieved regardless of the operating environment.

The binder resin may contain a polyester other than the polyester A, for example, a styrene acrylic resin, an epoxy resin, a polyester, a polyurethane, a polyamide, a cellulose resin, a polyether resin, a mixed resin or a composite resin thereof, or the like.

### Polyester A

As described above, the polyester A needs to contain the unit Uᵢₛₒ derived from isophthalic acid in an amount of 90% by mole or more, preferably 95% by mole or more, based on all units derived from an acid component.

The polyester A used in the toner particles can be an amorphous polyester.

The unit derived from isophthalic acid may be used as an essential component, and examples thereof include the following.

A polyester can be synthesized by combining suitable compounds selected from a polycarboxylic acid, a polyol, a hydroxycarboxylic acid, and the like and by using a known method, such as a transesterification method or a polycondensation method. The polyester can include a condensation polymer of a dicarboxylic acid and a diol.

The polycarboxylic acid is a compound with two or more carboxy groups per molecule. In particular, the dicarboxylic acid is a compound with two carboxy groups per molecule and is often used.

Examples thereof include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Examples of polycarboxylic acids other than the dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. These may be used alone or in combination.

The polyol is a compound with two or more hydroxy groups per molecule. In particular, a diol is a compound with two hydroxy groups per molecule and is often used.

Specific examples thereof include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, poly(ethylene glycol), poly(propylene glycol), polytetramethylene ether glycol, 1,4-cyclohexanediol, 1,4-cyclohexanedimethanol, 1,4-butenediol, neopentyl glycol, poly(tetramethylene glycol), hydrogenated bisphenol A, bisphenol A, bisphenol F, bisphenol S, and alkylene oxide (ethylene oxide, propylene oxide, butylene oxide, etc.) adducts of the bisphenols.

In particular, an alkylene glycol with 2 or more and 12 or less carbon atoms or an alkylene oxide adduct of a bisphenol, particularly an alkylene oxide adduct of a bisphenol or a combination thereof with an alkylene glycol with 2 or more and 12 or less carbon atoms can be used. An alkylene oxide adduct of bisphenol A may be a compound represented by the following formula (A):

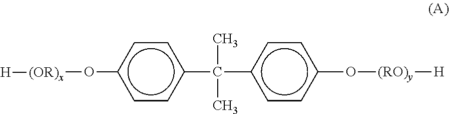

wherein R each independently denotes an ethylene or propylene group, x and y each denote an integer of 0 or more, and the average value of x+y is 0 or more and 10 or less.

The alkylene oxide adduct of bisphenol A can be a propylene oxide adduct and/or an ethylene oxide adduct of bisphenol A. In particular, it can be a propylene oxide adduct. The average value of x+y is preferably 1 or more and 5 or less.

Examples of trihydric or higher polyhydric alcohols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of trihydric or higher polyphenols. These may be used alone or in combination.

The polyester A preferably has an acid value of 4.0 mgKOH/g or more and 10.0 mgKOH/g or less.

### Release Agent

A known release agent can be used in the toner.

Specific examples thereof include petroleum waxes and derivatives thereof, such as paraffin waxes, microcrystalline waxes, and petrolatum, montan wax and derivatives thereof, Fischer-Tropsch hydrocarbon waxes and derivatives thereof, polyolefin waxes and derivatives thereof, such as polyethylene, and natural waxes and derivatives thereof, such as carnauba wax and candelilla wax. Examples of the derivatives include oxides, block copolymers with a vinyl monomer, and graft-modified products.

Also included are alcohols, such as higher aliphatic alcohols; fatty acids, such as stearic acid and palmitic acid, and acid amides, esters, and ketones thereof; hydrogenated castor oil and derivatives thereof, plant waxes, and animal waxes. These may be used alone or in combination.

Among these, polyolefin, Fischer-Tropsch hydrocarbon waxes, and petroleum waxes tend to improve developability and transferability. An antioxidant may be added to these waxes without affecting the effects of the toner. From the perspective of the phase separability from the binder resin or the crystallization temperature, higher fatty acid esters, such as behenyl behenate and dibehenyl sebacate, can be suitably exemplified.

The release agent content is preferably 1.0 part by mass or more and 30.0 parts by mass or less per 100.0 parts by mass of the binder resin.

The release agent preferably has a melting point of 30° C. or more and 120° C. or less, more preferably 60° C. or more and 100° C. or less. A release agent with such thermal properties can be used to efficiently exhibit the release effects and ensure a wider fixing region.

### Plasticizer

The toner particles may contain a crystalline plasticizer to improve the sharp melt property. The plasticizer may be, but is not limited to, a known plasticizer for use in toner, as described below.

Specific examples thereof include esters of a monohydric alcohol and an aliphatic carboxylic acid and esters of a monovalent carboxylic acid and an aliphatic alcohol, such as behenyl behenate, stearyl stearate, and palmityl palmitate; esters of a dihydric alcohol and an aliphatic carboxylic acid and esters of a divalent carboxylic acid and an aliphatic alcohol, such as ethylene glycol distearate, dibehenyl sebacate, and hexanediol dibehenate; esters of a trihydric alcohol and an aliphatic carboxylic acid and esters of a trivalent carboxylic acid and an aliphatic alcohol, such as glycerin tribehenate; esters of a tetrahydric alcohol and an aliphatic carboxylic acid and esters of a tetravalent carboxylic acid and an aliphatic alcohol, such as pentaerythritol tetrastearate and pentaerythritol tetrapalmitate; esters of a hexahydric alcohol and an aliphatic carboxylic acid and esters of a hexavalent carboxylic acid and an aliphatic alcohol, such as dipentaerythritol hexastearate and dipentaerythritol hexapalmitate; esters of a polyhydric alcohol and an aliphatic carboxylic acid and esters of a polycarboxylic acid and an aliphatic alcohol, such as polyglycerin behenate; and natural ester waxes, such as carnauba wax and rice wax. These may be used alone or in combination.

### Crystalline Polyester

The toner particles can contain a crystalline polyester. The crystalline polyester can be a polycondensate of a monomer containing an aliphatic diol and/or an aliphatic dicarboxylic acid. The crystalline polyester refers to a polyester with a clear melting point as measured with a differential scanning calorimeter (DSC).

The crystalline polyester can contain a monomer unit derived from an aliphatic diol with 2 or more and 12 or less (more preferably 6 or more and 12 or less) carbon atoms and/or a monomer unit derived from an aliphatic dicarboxylic acid with 2 or more and 12 or less (more preferably 6 or more and 12 or less) carbon atoms.

The crystalline polyester with such a structure has high dispersibility between toner particles, can suppress the nonuniformity of wetting and spreading among the toner particles at the time of fixing, and improves the low-temperature fixability.

The aliphatic diol with 2 or more and 12 or less carbon atoms may be the following compound.

1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, or 1,12-dodecanediol. An aliphatic diol with a double bond may also be used. The aliphatic diol with a double bond may be the following compound. 2-butene-1,4-diol, 3-hexene-1,6-diol, or 4-octene-1,8-diol. The aliphatic dicarboxylic acid with 2 or more and 12 or less carbon atoms may be the following compound. Oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, or 1,12-dodecanedicarboxylic acid. A lower alkyl ester or an acid anhydride of the aliphatic dicarboxylic acid may also be used. In particular, sebacic acid, adipic acid, 1,10-decanedicarboxylic acid, or a lower alkyl ester or an acid anhydride thereof can be used. These may be used alone or in combination. An aromatic carboxylic acid may also be used. The aromatic dicarboxylic acid may be the following compound. Terephthalic acid, isophthalic acid, 2,6-naphthalenedicarboxylic acid, or 4,4′-biphenyldicarboxylic acid. Among these, terephthalic acid is easily available and easily forms a polymer with a low melting point.

A dicarboxylic acid with a double bond may also be used. The dicarboxylic acid with a double bond can be suitably used to suppress hot offset at the time of fixing from the perspective that the entire resin can be cross-linked by utilizing the double bond.

Such a dicarboxylic acid may be fumaric acid, maleic acid, 3-hexenedioic acid, or 3-octenedioic acid. A lower alkyl ester or an acid anhydride thereof may also be mentioned. In particular, fumaric acid or maleic acid can be used.

The crystalline polyester can be produced by any method, for example, a typical polyester polymerization method of reacting a dicarboxylic acid component and a diol component. For example, a direct polycondensation method or a transesterification method can be used depending on the type of monomer.

The acid value (mgKOH/g) of the crystalline polyester can be controlled to be low, more specifically, 8.0 or less, in consideration of dispersibility in the toner. It is preferably 5.0 or less, more preferably 3.5 or less, particularly preferably 3.0 or less.

The peak temperature of the maximum endothermic peak of the crystalline polyester as measured with a differential scanning calorimeter (DSC) is preferably 50.0° C. or more and 100.0° C. or less, more preferably 60.0° C. or more and 90.0° C. or less from the perspective of the low-temperature fixability.

The crystalline polyester content of the toner is preferably 3.0% by mass or more and 15.0% by mass or less from the perspective of the balance between the low-temperature fixability and the durability.

### Colorant

The toner particles may contain a colorant. The colorant may be a known pigment or dye. From the perspective of high weatherability, the colorant can be a pigment. A cyan colorant, such as a copper phthalocyanine compound or a derivative thereof, an anthraquinone compound, or a basic dye lake compound, may be used.

Specific examples thereof include the following. C.I. Pigment Blue 1, 7, 15, 15:1, 15:2, 15:3, 15:4, 60, 62, or 66.

A magenta colorant, such as a condensed azo compound, a diketopyrrolopyrrole compound, an anthraquinone compound, a quinacridone compound, a basic dye lake compound, a naphthol compound, a benzimidazolone compound, a thioindigo compound, or a perylene compound, may be used.

Specific examples thereof include the following. C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, or 254, or C.I. Pigment violet 19.

A yellow colorant, such as a condensed azo compound, an isoindolinone compound, an anthraquinone compound, an azo metal complex, a methine compound, or an allylamide compound, may be used.

Specific examples thereof include the following. C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, or 194.

A black colorant, such as a colorant adjusted to black using the yellow colorant, the magenta colorant, or the cyan colorant, carbon black, or a magnetic material, may be used. These colorants may be used alone or in combination or may be used in the form of solid solution. The colorant is preferably used in an amount of 1.0 part by mass or more and 20.0 parts by mass or less per 100.0 parts by mass of the binder resin. When a production method in an aqueous medium described later is applied using a magnetic material, a hydrophobization treatment may be performed to stably incorporate the magnetic material in a resin.

### Charge Control Agent and Charge Control Resin

The toner particles may contain a charge control agent or a charge control resin. The charge control agent may be a known charge control agent, particularly a charge control agent that has a high triboelectric charging speed and that can stably maintain a certain triboelectric charging amount. Furthermore, when the toner particles are produced by a suspension polymerization method, the charge control agent can have small polymerization inhibition effects and can be substantially free of substances soluble in aqueous media.

A material for controlling the toner to be negatively charged may be a monoazo metal compound, an acetylacetone metal compound, an aromatic oxycarboxylic acid, an aromatic dicarboxylic acid, an oxycarboxylic acid or dicarboxylic acid metal compound, an aromatic oxycarboxylic acid, an aromatic mono or polycarboxylic acid or a metal salt, an anhydride, or an ester thereof, a phenol derivative, such as bisphenol, a urea derivative, a metal-containing salicylic acid compound, a metal-containing naphthoic acid compound, a boron compound, a quaternary ammonium salt, a calixarene, a charge control resin, or the like.

The charge control resin may be a polymer or copolymer with a sulfonic acid group, a sulfonic acid salt group, or a sulfonic ester group. The polymer with a sulfonic acid group, a sulfonic acid salt group, or a sulfonic ester group is particularly preferably a polymer containing an acrylamide monomer with a sulfonic acid group or a methacrylamide monomer with a sulfonic acid group in a copolymerization ratio of 2% by mass or more, more preferably 5% by mass or more.

The charge control resin preferably has a glass transition temperature (Tg) of 35° C. or more and 90° C. or less, a peak molecular weight (Mp) of 10,000 or more and 30,000 or less, and a weight-average molecular weight (Mw) of 25,000 or more and 50,000 or less. This can impart favorable triboelectric charging characteristics without affecting the thermal properties required for the toner particles. Furthermore, the charge control resin with a sulfonic acid group can improve, for example, the dispersibility of the charge control resin itself or the dispersibility of a colorant or the like in the polymerizable monomer composition, and further improve the tinting strength, transparency, and triboelectric charging characteristics.

These charge control agents or charge control resins may be added alone or in combination. The amount of the charge control agent or the charge control resin to be added is preferably 0.01 parts by mass or more and 20.0 parts by mass or less, more preferably 0.5 parts by mass or more and 10.0 parts by mass or less, per 100.0 parts by mass of the binder resin.

### External Additive

In addition to the hydrotalcite particles, an inorganic external additive or the like may be mixed and attached to the surface of the toner. The inorganic external additive is, for example, silica, strontium titanate, a fatty acid metal salt, alumina, or fine metal oxide particles (fine inorganic particles), such as titanium oxide, cerium oxide fine particles, or calcium carbonate fine particles.

It is also possible to use fine resin particles or fine organic-inorganic composite particles of fine resin particles and fine inorganic particles.

The external additive may be subjected to a hydrophobization treatment with a hydrophobic treatment agent.

The hydrophobic treatment agent is, for example, a chlorosilane, such as methyltrichlorosilane, dimethyldichlorosilane, trimethylchlorosilane, phenyltrichlorosilane, diphenyldichlorosilane, t-butyldimethylchlorosilane, or vinyltrichlorosilane;
an alkoxysilane, such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, or 7-(2-aminoethyl)aminopropylmethyldimethoxysilane;
silazane, such as hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, or dimethyltetravinyldisilazane;
silicone oil, such as dimethyl silicone oil, methyl hydrogen silicone oil, methylphenyl silicone oil, alkyl-modified silicone oil, chloroalkyl-modified silicone oil, chlorophenyl-modified silicone oil, fatty-acid-modified silicone oil, polyether-modified silicone oil, alkoxy-modified silicone oil, carbinol-modified silicone oil, amino-modified silicone oil, fluorine-modified silicone oil, or terminal reactive silicone oil;
siloxane, such as hexamethylcyclotrisiloxane, octamethylcyclotetrasiloxane, decamethylcyclopentasiloxane, hexamethyldisiloxane, or octamethyltrisiloxane; or
a fatty acid or a metal salt thereof, for example, a long-chain fatty acid, such as undecylic acid, lauric acid, tridecylic acid, dodecylic acid, myristic acid, palmitic acid, pentadecylic acid, stearic acid, heptadecylic acid, arachidic acid, montanic acid, oleic acid, linoleic acid, or arachidonic acid, or a salt of the fatty acid and a metal, such as zinc, iron, magnesium, aluminum, calcium, sodium, or lithium.

Among these, an alkoxysilane, a silazane, and silicone oil facilitate hydrophobization treatment. These hydrophobic treatment agents may be used alone or in combination.

The external additive content is preferably 0.05 parts by mass or more and 10.0 parts by mass or less per 100 parts by mass of the toner particles.

### Method for Producing Toner

The method for producing toner may be, but is not limited to, a known production method. The method for producing toner may be a kneading and pulverization method, a wet production method, or the like. The wet production method can be used from the perspective of easily obtaining a core-shell particle structure, making the particle size uniform, and controlling the shape. The wet production method may be a suspension polymerization method, a dissolution suspension method, an emulsion polymerization and aggregation method, an emulsion aggregation method, or the like, particularly the emulsion aggregation method. That is, the method for producing toner particles can include a step of aggregating fine particles of a binder resin to form an agglomerate and a step of fusing the agglomerate to produce toner particles. The toner particles can be emulsion aggregation toner particles. This is because a core aggregated in an aqueous medium is easily covered with a desired shell to produce core-shell particles.

A method for producing toner particles by an emulsion aggregation method is described in detail below by way of example.

### Dispersion Liquid Preparation Step

A binder resin particle dispersion liquid is prepared, for example, as described below. When the binder resin is a homopolymer or copolymer of a vinyl monomer (vinyl resin), the vinyl monomer is subjected to emulsion polymerization, seed polymerization, or the like in an ionic surfactant to prepare a dispersion liquid containing vinyl resin particles dispersed in the ionic surfactant. When the binder resin is a resin other than the vinyl resin, such as a polyester, the resin is mixed with an aqueous medium containing an ionic surfactant or a polymer electrolyte dissolved therein.

The solution is then heated to a temperature equal to or higher than the melting point or softening point of the resin to dissolve the resin, and binder resin particles are dispersed in the ionic surfactant using a dispersing apparatus with a strong shear force, such as a homogenizer, to prepare a dispersion liquid.

The dispersing unit is, for example, but not limited to, a known dispersing apparatus, such as a rotary shearing homogenizer, or a ball mill, a sand mill, or a Dyno-Mill with a medium.

A phase-inversion emulsification method may be used as a method of preparing a dispersion liquid. The phase-inversion emulsification method includes dissolving a binder resin in an organic solvent, adding a neutralizing agent or a dispersion stabilizer as necessary, adding dropwise an aqueous solvent with stirring to produce emulsified particles, and then removing the organic solvent from the resin dispersion liquid to produce an emulsion. At this time, the order of adding the neutralizing agent and the dispersion stabilizer may be changed.

The binder resin particles typically have a number-average particle diameter of 1 μm or less, preferably 0.01 μm or more and 1.00 μm or less. A number-average particle diameter of 1.00 μm or less results in the finally produced toner with a suitable particle size distribution and fewer free particles. A number-average particle diameter in the above range results in a decrease in uneven distribution in the toner, improved dispersion in the toner, and a decrease in variations in performance and reliability.

In the emulsion aggregation method, if necessary, a colorant particle dispersion liquid may be used. The colorant particle dispersion liquid is produced by dispersing at least colorant particles in a dispersant. The colorant particles preferably have a number-average particle diameter of 0.5 μm or less, more preferably 0.2 μm or less. A number-average particle diameter of 0.5 μm or less results in no diffuse reflection of visible light and easy aggregation of the binder resin particles and the colorant particles in an aggregation step. A number-average particle diameter in the above range results in a decrease in uneven distribution in the toner, improved dispersion in the toner, and a decrease in variations in performance and reliability.

In the emulsion aggregation method, if necessary, a wax particle dispersion liquid may be used. The wax particle dispersion liquid is produced by dispersing at least wax particles in a dispersant. The wax particles preferably have a number-average particle diameter of 2.0 μm or less, more preferably 1.0 μm or less. A number-average particle diameter of 2.0 μm or less results in slight variations in the wax content among the toner particles and an image with high stability for an extended period. A number-average particle diameter in the above range results in a decrease in uneven distribution in the toner, improved dispersion in the toner, and a decrease in variations in performance and reliability.

The combination of the colorant particles, the binder resin particles, and the wax particles is not particularly limited and may be appropriately selected depending on the intended purpose. In addition to the dispersion liquid, another particle dispersion liquid produced by dispersing appropriately selected particles in a dispersant may be further mixed. The particles contained in the other particle dispersion liquid are not particularly limited, may be appropriately selected depending on the intended purpose, and are, for example, internal additive particles, charge control agent particles, inorganic particles, abrasive particles, or the like. These particles may be dispersed in the binder resin particle dispersion liquid or the colorant particle dispersion liquid.

The dispersant contained in the binder resin particle dispersion liquid, the colorant particle dispersion liquid, the wax particle dispersion liquid, or another particle dispersion liquid is, for example, an aqueous medium containing a polar surfactant, or the like. The aqueous medium is, for example, water, such as distilled water or deionized water, an alcohol, or the like. These may be used alone or in combination. The polar surfactant content cannot be unconditionally specified and can be appropriately selected depending on the intended purpose.

The polar surfactant is, for example, an anionic surfactant, such as a sulfate, a sulfonate, a phosphate, or a soap, a cationic surfactant, such as an amine salt or a quaternary ammonium salt, or the like. Specific examples of the anionic surfactant include sodium dodecylbenzene sulfonate, sodium tetradecylbenzene sulfonate, sodium dodecyl sulfate, sodium alkylnaphthalene sulfonate, sodium dialkyl sulfosuccinate, and the like. Specific examples of the cationic surfactant include alkylbenzene dimethyl ammonium chloride, alkyltrimethyl ammonium chloride, distearyl ammonium chloride, and the like. These may be used alone or in combination.

The polar surfactant can be an alkylbenzene sulfonate having an alkyl group with 12 or more and 14 or less carbon atoms in terms of good fine line reproducibility in a low-temperature and low-humidity environment.

Although the reason why this effect is obtained is not clear, the alkylbenzene sulfonate is negatively charged, is attracted to a surface positively charged layer of hydrotalcite with a layered structure, and therefore adheres easily and uniformly to the toner surface. It is surmised that this achieves a uniform charge distribution at a higher level and improves the fine line reproducibility in a low-temperature and low-humidity environment. Furthermore, it is thought that the alkyl group with 12 or more and 14 or less carbon atoms can appropriately increase the molecular weight and easily maintain high image quality. The alkyl group of the alkylbenzene sulfonic acid and/or alkylbenzene sulfonate can be linear and preferably has 10 to 14 carbon atoms. More specifically, preferred embodiments include decylbenzene sulfonic acid and/or a salt thereof (with 10 carbon atoms), undecylbenzene sulfonic acid and/or a salt thereof (with 11 carbon atoms), dodecylbenzene sulfonic acid and/or a salt thereof (with 12 carbon atoms), and tetradecylbenzene sulfonic acid and/or a salt thereof (with 14 carbon atoms). A monovalent or divalent metal, such as sodium, potassium, magnesium, or calcium, may constitute the alkylbenzene sulfonate. From the perspective of good fine line reproducibility in a lower-temperature and lower-humidity environment, a monovalent metal can be used, and sodium can be used. Specific examples include sodium decylbenzene sulfonate (10 carbon atoms), sodium undecylbenzene sulfonate (11 carbon atoms), sodium dodecylbenzene sulfonate (12 carbon atoms), and sodium tetradecylbenzene sulfonate (14 carbon atoms), particularly sodium dodecylbenzene sulfonate.

The alkylbenzene sulfonic acid and/or the alkylbenzene sulfonate may be incorporated into the toner by any method, for example, by using a compound containing the alkylbenzene sulfonic acid and/or the alkylbenzene sulfonate in any step of a toner production process so that the resulting toner contains the alkylbenzene sulfonate.

Examples thereof include a method of adding a compound containing the alkylbenzene sulfonic acid and/or the alkylbenzene sulfonate as a material constituting the toner and, when the toner is produced by the emulsion aggregation method, a method of using the alkylbenzene sulfonic acid and/or the alkylbenzene sulfonate as a surfactant to prepare a dispersion liquid, such as a fine resin particle dispersion liquid, a colorant particle dispersion liquid, or a release agent particle dispersion liquid, so that the resulting toner contains the alkylbenzene sulfonate.

Whether or not the toner contains the alkylbenzene sulfonic acid and/or the alkylbenzene sulfonate can be determined by a method described in Exemplary Embodiments. The alkylbenzene sulfonic acid or alkylbenzene sulfonate content (on a mass basis) is preferably 10 ppm or more and 1000 ppm or less of the toner.

These polar surfactants and nonpolar surfactants may be used in combination. The nonpolar surfactant is, for example, a nonionic surfactant, such as poly(ethylene glycol), an alkylphenol ethylene oxide adduct, or a polyhydric alcohol, or the like.

The colorant particle content is preferably 0.1 parts by mass or more and 30 parts by mass or less per 100 parts by mass of the binder resin in an agglomerate dispersion liquid when an agglomerate is formed.

The wax particle content is preferably 0.5 parts by mass or more and 25 parts by mass or less, more preferably 5 parts by mass or more and 20 parts by mass or less, per 100 parts by mass of the binder resin in an agglomerate dispersion liquid when an agglomerate is formed.

Furthermore, to more precisely control the chargeability of the resulting toner, charge control particles and binder resin particles may be added after an agglomerate is formed.

The particle size of particles, such as binder resin particles or colorant particles, is measured with a laser diffraction/scattering particle size distribution analyzer LA-960V2 manufactured by Horiba, Ltd.

### Aggregation Step

An aggregation step of forming an agglomerate is a step of forming an agglomerate containing binder resin particles and optionally colorant particles, wax particles, and the like in an aqueous medium containing the binder resin particles and optionally the colorant particles, the wax particles, and the like.

The agglomerate can be formed in an aqueous medium, for example, by adding an aggregating agent, a pH adjuster, and a stabilizer to the aqueous medium, mixing them, and appropriately applying heat, mechanical power, or the like.

The aggregating agent may be, a salt of a monovalent metal, such as sodium or potassium; a salt of a divalent metal, such as calcium or magnesium; a salt of a trivalent metal, such as iron or aluminum; or an alcohol, such as methanol, ethanol, or propanol. The aggregating agent can be an aggregating agent that has a high cohesive force, that can cause aggregation by adding a small amount thereof, and that contains a divalent or polyvalent metal element.

Specific examples thereof include divalent inorganic metal salts, such as calcium chloride, calcium nitrate, magnesium chloride, magnesium sulfate, and zinc chloride. Also included are trivalent metal salts, such as iron (III) chloride, iron (III) sulfate, aluminum sulfate, and aluminum chloride. Also included are inorganic metal salt polymers, such as polyaluminum chloride, polyaluminum hydroxide, polyferric sulfate, and calcium polysulfide. The aggregating agent is not limited to these. These may be used alone or in combination. From the perspective of controlling the amount of aluminum element in toner particles, an aluminum metal salt can be used.

The pH adjuster may be an alkali, such as ammonia or sodium hydroxide, or an acid, such as nitric acid or citric acid.

The stabilizer may be a polar surfactant, an aqueous medium containing the polar surfactant, or the like. For example, when the polar surfactant contained in each particle dispersion liquid is anionic, a cationic stabilizer can be selected.

The aggregating agent or the like may be added in the form of a dry powder or an aqueous solution of the aggregating agent dissolved in an aqueous medium and can be added in the form of an aqueous solution to cause uniform aggregation.

The aggregating agent or the like can be added and mixed at a temperature equal to or lower than the glass transition temperature of a resin contained in an aqueous medium. When mixing is performed under this temperature condition, aggregation proceeds in a stable state. The mixing can be performed, for example, using a known mixing apparatus, homogenizer, mixer, or the like.

Furthermore, toner particles with a core-shell structure in which the shell is formed on the core surface can be produced by applying a dispersion liquid containing a polyester to the surface of an agglomerate to form the shell in the aggregation step. The aggregation step may be repeatedly performed in a stepwise manner multiple times.

### Fusion Step

The fusion step is a step of heating and fusing the resulting agglomerate. To prevent fusion of toner particles, a pH adjuster, a polar surfactant, a nonpolar surfactant, or the like can be appropriately added before the fusion step. The heating temperature may range from the glass transition temperature of the resin contained in the agglomerate (for two or more types of resins, the glass transition temperature of the resin with the highest glass transition temperature) to the decomposition temperature of the resin. Thus, the heating temperature varies with the type of the resin in the binder resin particles and cannot be unconditionally specified but typically ranges from the glass transition temperature of the resin contained in the agglomerate to 140° C. The heating can be performed with a known heating device or instrument.

The fusion time is short at a high heating temperature and is long at a low heating temperature. That is, the fusion time depends on the heating temperature, cannot be unconditionally specified, but is typically 30 minutes or more and 10 hours or less.

### Step of Obtaining Desired Surface Profile of Toner Spheronization Step

During the fusion step or after the fusion step, a spheronization step of further increasing the temperature and holding the temperature until the toner particles have a desired circularity or surface profile can be performed. The specific temperature of the spheronization step is, for example, 90° C. or more, preferably 92° C. or more, and preferably 95° C. or less. The heating time in the spheronization step is, for example, 3 hours or more, 5 hours or more, or 8 hours or more.

### Cooling Step

The spheronization step can be followed by a cooling step of controlling the cooling rate to cool the temperature of the dispersion liquid containing the resulting toner particles to a temperature lower than the crystallization temperature or the glass transition temperature of the binder resin. The cooling step can suppress the formation of concavities and convexities on the toner particle surface due to a volume change, such as expansion or contraction, of a material in the toner particles. The specific cooling rate is 0.1° C./s or more, preferably 0.5° C./s or more, more preferably 2° C./s or more, still more preferably 4° C./s or more.

### Annealing Step

The cooling step can be followed by an annealing step of heating and holding at a temperature equal to or higher than the crystallization temperature or the glass transition temperature of the binder resin and equal to or lower than the crystallization temperature of a release agent in the case where the release agent is contained. The annealing step can further suppress the volume change and can therefore suppress the occurrence of a recess on the toner particle surface. Thus, the desired circularity or surface profile obtained through the cooling step can be maintained. The specific annealing temperature is 45° C. or more and 75° C. or less, preferably 50° C. or more and 70° C. or less, more preferably 55° C. or more and 65° C. or less. The heat-treatment time in the annealing step is, for example, 5 hours or less, preferably 2 to 3 hours.

### Post-Treatment Step

The toner particles produced through these steps can be subjected to solid-liquid separation by a known method to collect the toner particles and can then be washed, dried, and the like under appropriate conditions.

### External Addition Step

In an external addition step, hydrotalcite particles are externally added to the toner particles thus produced. If necessary, other known fine particles may be used in combination.

### Methods for Measuring Physical Properties

Methods for measuring physical properties according to the present disclosure are described below.

### Method for Identifying Hydrotalcite Particles

The hydrotalcite particles as an external additive can be identified by a combination of shape observation with a scanning electron microscope (SEM) and elemental analysis by energy dispersive X-ray spectroscopy (EDS).

Toner is observed in a field of view magnified up to 50,000 times using a scanning electron microscope “S-4800” (trade name, manufactured by Hitachi, Ltd.). The toner particle surface is focused to observe the target external additive. The target external additive can be subjected to EDS analysis to identify the hydrotalcite particles from the types of element peaks.

The presence of hydrotalcite particles containing two types of metals can be inferred from the observation of an element peak of at least one metal selected from the group consisting of Mg, Zn, Ca, Ba, Ni, Sr, Cu, and Fe, which can constitute the hydrotalcite particles, and an element peak of at least one metal selected from the group consisting of Al, B, Ga, Fe, Co, and In.

An authentic sample of hydrotalcite particles inferred by EDS analysis is separately prepared and is subjected to shape observation by SEM and EDS analysis. The analysis results of the authentic sample are compared with the analysis results of the target particles to determine whether or not the particles are hydrotalcite particles.

### Method for Measuring Hydrotalcite Particle Content h (%) of Toner

The hydrotalcite particle content h (%) of the toner on a mass basis can be quantified by x-ray fluorescence analysis using a calibration curve prepared from a standard sample. The fluorescent X-rays of each element are measured in accordance with JIS K 0119-1969, as specifically described below.

The measuring apparatus is a wavelength-dispersive X-ray fluorescence analyzer “Axios” (manufactured by PANalytical) using attached dedicated software “SuperQ ver. 4.0F” (manufactured by PANalytical) for specifying measurement conditions and analyzing measured data. Rh is used as an anode of an X-ray tube, the measurement atmosphere is vacuum, the measurement diameter (collimator mask diameter) is 27 mm, and the measurement time is 10 seconds. A light element is detected with a proportional counter (PC), and a heavy element is detected with a scintillation counter (SC).

Approximately 4 g of toner is put into a special-purpose aluminum ring for pressing, is flattened, and is pressed at 20 MPa for 60 seconds using a tablet molding machine to form a pellet with a thickness of approximately 2 mm and a diameter of approximately 39 mm as a measurement sample. The tablet molding machine was “BRE-32” manufactured by Maekawa Testing Machine Mfg. Co., Ltd.

In the measurement under the above conditions, an element is identified based on the peak position of the resulting X-rays, and the concentration thereof is calculated from the counting rate (unit: cps), which is the number of X-ray photons per unit time.

0.10 parts by mass of a separately prepared authentic sample of hydrotalcite particles is added to 100 parts by mass of toner particles and is sufficiently mixed using a coffee mill. Likewise, 0.20 parts by mass or 0.50 parts by mass of hydrotalcite particles are mixed with toner particles and are used as specimens for a calibration curve.

For each specimen, the counting rate (unit: cps) derived from a metal element in the hydrotalcite is measured. In this case, the accelerating voltage and the current value of an X-ray generator are 24 kV and 100 mA, respectively. A linear calibration curve is obtained by plotting the X-ray counting rate on the vertical axis and the amount of hydrotalcite particles added in each specimen for a calibration curve on the horizontal axis.

Toner to be analyzed is then formed into a pellet as described above using a tablet molding machine, and the counting rate derived from a metal element in the hydrotalcite is measured. The hydrotalcite particle content h (%) of the toner is then determined from the calibration curve.

### Method for Measuring Each Element Ratio of Hydrotalcite Particles

Each element ratio of hydrotalcite particles is measured by EDS mapping measurement of toner using a scanning transmission electron microscope (STEM). The EDS mapping measurement has spectral data for each picture element (pixel) in the analysis area. A silicon drift detector with a large sensing element area can be used to measure EDS mapping with high sensitivity.

The spectral data of each pixel obtained by the EDS mapping measurement can be subjected to statistical analysis to obtain principal component mapping in which pixels with similar spectra are extracted, thus enabling mapping in which components are specified.

An observation sample is prepared by the following procedure.

0.5 g of toner is weighed in a cylindrical mold with a diameter of 8 mm and is allowed to stand for 2 minutes at a load of 40 kN using a Newton press to prepare a cylindrical toner pellet with a diameter of 8 mm and a thickness of approximately 1 mm. A 200-nm thick slice is prepared from the toner pellet using an ultramicrotome (Leica, FC7).

The STEM-EDS analysis is performed using the following apparatuses and conditions.
Scanning transmission electron microscope: JEM-2800 manufactured by JEOL Ltd.
EDS detector: JED-2300T Dry SD100GV detector (sensing element area: 100 mm²) manufactured by JEOL Ltd.
EDS analyzer: NORAN System 7 manufactured by Thermo Fisher Scientific Inc.

### Conditions for STEM-EDS

STEM accelerating voltage: 200 kV
Magnification: 20,000
Probe size: 1 nm
STEM image size: 1024×1024 pixels (An EDS elemental mapping image at the same position is acquired).
EDS mapping size: 256×256 pixels
Dwell Time: 30 μs
Number of scans: 100 frames

Each element ratio in the hydrotalcite particles based on multivariate analysis is calculated as described below.

An EDS mapping is obtained by the STEM-EDS analyzer. Multivariate analysis is then performed on the collected spectral mapping data using the COMPASS (PCA) mode in the measurement command of the NORAN System 7 to extract a principal component map image.

At this time, the set values are as follows:
Kernel size: 3×3
Quantitative map setting: high (slow)
Filter fit type: high precision (slow)

At the same time, the area ratio of each extracted main component in the EDS measurement field of view is calculated by this operation. The EDS spectrum of each principal component mapping is subjected to quantitative analysis by the Cliff-Lorimer method.

A toner particle portion and the hydrotalcite particles are distinguished based on the quantitative analysis results of the STEM-EDS principal component mapping. Particles can be identified as hydrotalcite particles from the particle size, the shape, the polyvalent metal content, such as the aluminum content or the magnesium content, and the content ratio thereof.

The presence of fluorine and aluminum within hydrotalcite particles can be determined by the following means.

### Method for Analyzing Fluorine and Aluminum in Hydrotalcite Particles

Based on the mapping data by the STEM-EDS mapping analysis obtained by the above method, fluorine and aluminum in the hydrotalcite particles are analyzed. More specifically, EDS line analysis is performed in the direction normal to the outer periphery of the hydrotalcite particles to analyze fluorine and aluminum present within the particles.

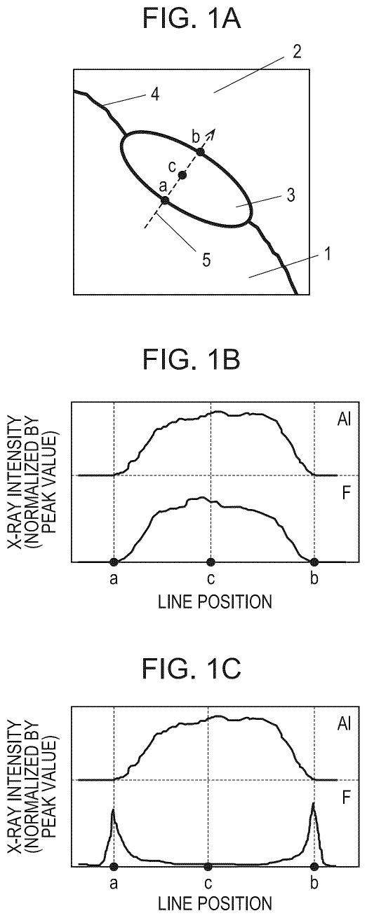

FIG. 1A is a schematic view of the line analysis. In a hydrotalcite particle 3 adjacent to a toner particle 1 and a toner particle 2, line analysis is performed in the direction 5 normal to the outer periphery of the hydrotalcite particle 3. Reference numeral 4 denotes a boundary of the toner particles.

The range where the hydrotalcite particles are present in the acquired STEM image is selected with a rectangle selection tool and is subjected to line analysis under the following conditions.

### Line Analysis Conditions

STEM magnification: 800,000
Line length: 200 nm
Line width: 30 nm
Line division number: 100 points (intensity measurement for each 2 nm)

In an EDS spectrum of a hydrotalcite particle, when the element peak intensity of fluorine or aluminum is 1.5 times or more the background intensity, and when the element peak intensity of fluorine or aluminum at both ends (the point a and the point b in FIG. 1A) of the hydrotalcite particle in the line analysis does not exceed 3.0 times the peak intensity at the point c, it is determined that the element is contained inside the hydrotalcite particle. The point c is the midpoint of the line segment ab (that is, the midpoint between the both ends).

Examples of the X-ray intensities of fluorine and aluminum obtained by the line analysis are shown in FIG. 1B and FIG. 1C. When the hydrotalcite particles contain fluorine and aluminum inside, the graph of the X-ray intensity normalized by the peak intensity is shown in FIG. 1B. When the hydrotalcite particles contain fluorine derived from the surface treatment agent, the graph of the X-ray intensity normalized by the peak intensity has peaks near the points a and b at both ends in the graph of fluorine, as shown in FIG. 1C. It can be confirmed by the X-ray intensities derived from fluorine and aluminum in the line analysis that the hydrotalcite particles contain fluorine and aluminum inside.

### Method for Calculating Atomic Number Concentration Ratio (Element Ratio) F/Al of Fluorine to Aluminum in Hydrotalcite Particles

The atomic number concentration ratio (element ratio) F/Al of fluorine to aluminum in the hydrotalcite particles is determined by acquiring the atomic number concentration ratio (element ratio) F/Al of fluorine to aluminum in the hydrotalcite particles, which is determined from the principal component mapping derived from the hydrotalcite particles by the STEM-EDS mapping analysis, in a plurality of fields of view and taking the arithmetic mean of 100 or more of the particles.

### Method for Calculating Atomic Number Concentration Ratio (Element Ratio) Mg/Al of Magnesium to Aluminum in Hydrotalcite Particles

The atomic number concentration ratio (element ratio) Mg/Al of magnesium to aluminum in the hydrotalcite particles is calculated in the same manner as the atomic number concentration ratio (element ratio) F/Al of fluorine to aluminum in the hydrotalcite particles.

### Method for Measuring Number-Average Particle Diameter of Primary Particles of Hydrotalcite Particles

The number-average particle diameter of hydrotalcite particles is measured by a combination of a scanning electron microscope “S-4800” (trade name, manufactured by Hitachi, Ltd.) and elemental analysis using energy dispersive X-ray spectroscopy (EDS). Toner to which an external additive is externally added is observed to photograph hydrotalcite particles in a field of view magnified up to 200,000 times. Hydrotalcite particles are selected from the photographed image to measure the long diameters of randomly selected 100 primary particles of the hydrotalcite particles and determine the number-average particle diameter. The observation magnification is appropriately adjusted for the size of the external additive. A particle that appears to be a single particle in observation is judged to be a primary particle.

Method for Isolating Binder Resin from Toner Particles
Method for Separating Binder Resin from Toner Particles

100 mg of toner particles is dissolved in 3 ml of chloroform. Insoluble matter is then removed by suction filtration with a syringe equipped with a sample treatment filter (pore size: 0.2 μm or more and 0.5 μm or less, for example, Myshori Disk H-25-2 (manufactured by Tosoh Corporation) or the like). Soluble matter is introduced into a preparative HPLC (apparatus: LC-9130 NEXT preparative column [60 cm] manufactured by Japan Analytical Industry Co., Ltd., exclusion limit: 20,000, 70,000, two columns connected), and a chloroform eluent is fed. When a peak is found in the resulting chromatograph, fractionation is performed at a retention time at which the molecular weight is 2,000 or more based on a monodisperse polystyrene standard sample. The solution of the resulting fraction is dried and solidified to separate a binder resin from a release agent.

### Composition Analysis of Binder Resin Composed of a Plurality of Components

The fractionated chloroform-soluble matter of the binder resin is used as a specimen. The concentration of toner particles in the specimen is adjusted to 0.1% by mass with chloroform, and the solution is passed through a 0.45-μm PTFE filter and is subjected to measurement. The gradient polymer LC measurement conditions are as follows:
Apparatus: ULTIMATE 3000 (manufactured by Thermo Fisher Scientific)
Mobile phase: A chloroform (HPLC), B acetonitrile (HPLC)
Gradient: 2 minutes (A/B=0/100)→25 minutes (A/B=100/0) (The gradient of the change in the mobile phase was linear.)
Flow rate: 1.0 mL/min
Injection: 0.1% by mass×20 μL
Column: Tosoh TSKgel ODS (4.6 mmφ×150 mm×5 μm)
Column temperature: 40° C.
Detector: corona charged particle detector (Corona-CAD) (manufactured by Thermo Fisher Scientific)

A time-intensity graph obtained by the measurement has a peak corresponding to a component with high polarity (resin A; polyester A) and a peak corresponding to a component with low polarity (resin B; crystalline polyester). When a resin other than the resin A and the resin B is contained, a peak corresponding to the polarity thereof is observed. The measurement is then performed again, and the resin A, the resin B, and the other resin can be separated from each other by fractionation at the time of a valley between peaks.

The resin A is fractionated at a time corresponding to the resin A (5 minutes to 10 minutes). The resin B is fractionated at a time corresponding to the resin B (11 minutes to 15 minutes). In the fractionation, a required amount of each of the chloroform/acetonitrile solutions thereof is collected, dried, and concentrated to prepare samples of the resin A and the resin B. For example, when there is another resin (such as a styrene acrylic resin) with a peak overlapping that of the resin B, peak separation by NMR is performed to calculate the mole ratio.

When the toner contains a release agent, it is necessary to separate the release agent from the toner. In the separation of the release agent, a component with a molecular weight of 2,000 or less is separated as the release agent by recycling HPLC. The measurement methods are described below. First, a chloroform solution of the toner is prepared by the method described above. The solution is passed through a solvent-resistant membrane filter “Myshori Disk” (manufactured by Tosoh Corporation) with a pore size of 0.2 μm to prepare a sample solution. The sample solution is adjusted so that the concentration of a chloroform-soluble component is 1.0% by mass. The sample solution is subjected to measurement under the following conditions.
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: chloroform
Flow rate: 10.0 ml/min
Oven temperature: 40.0° C.
Sample injection amount: 1.0 ml

The molecular weight of the specimen is calculated from a molecular weight calibration curve, which is prepared using standard polystyrene resins (for example, trade name “TSK standard polystyrene F-850, F-450, F-288, F-128, F-80, F-40, F-20, F-10, F-4, F-2, F-1, A-5000, A-2500, A-1000, and A-500”, manufactured by Tosoh Corporation). Based on the molecular weight curve thus obtained, a component with a molecular weight of 2,000 or less is repeatedly fractionated to remove the release agent from the toner. In the fractionation, a required amount of each of the chloroform/acetonitrile solutions thereof is collected, dried, and concentrated to prepare samples of the resin A component and the resin B component.

The samples of the resin A component and the resin B component are used to measure the component ratio and the mass ratio by nuclear magnetic resonance spectroscopy (NMR) as described below.

1 mL of deuterochloroform is added to 20 mg of each sample of the resin A component and the resin B component to measure an NMR spectrum of protons of the dissolved resin. The mole ratio and the mass ratio of each monomer can be calculated from the NMR spectrum to determine each monomer unit content. The mole ratio is calculated on the assumption that the smallest unit sandwiched by ester bonds is a structure derived from a monomer.

For the nuclear magnetic resonance spectroscopy (NMR), the following apparatus and measurement conditions can be used.
NMR apparatus: RESONANCE ECX500 manufactured by JEOL Ltd.
Nucleus observed: proton
Measurement mode: single pulse
Method for Quantifying Uᵢₛₒ, U_{EO}, and U_{PO} in Polyester A by NMR Measurement
Component identification and measurement of mole ratio and mass ratio of polyester A by nuclear magnetic resonance spectroscopy (NMR)

1 mL of deuterochloroform is added to 20 mg of the polyester A to measure an NMR spectrum of protons of the dissolved polyester A. The mole ratio and the mass ratio of each monomer were calculated from the NMR spectrum on the assumption that the smallest unit sandwiched by ester bonds was a structure derived from a monomer.

For example, the component ratio and the mass ratio can be calculated based on the following peaks (chemical shift value, number of protons).
Unit derived from isophthalic acid: 7.5 ppm (1), 8.2 ppm (2), 8.7 ppm (1)
Unit derived from terephthalic acid: 8.1 ppm (4)
Unit derived from ethylene oxide adduct of bisphenol A: 1.6 ppm (6), 4.3 ppm (4), 4.7 ppm (4), 6.8 ppm (4), 7.1 ppm (4)
Unit derived from propylene oxide adduct of bisphenol A: 1.5 ppm (6), 1.6 ppm (6), 4.1 ppm (4), 5.5 ppm (2), 6.8 ppm (4), 7.1 ppm (4)
Unit derived from ethylene glycol: 4.3 ppm (4)
NMR apparatus: JEOL RESONANCE ECX500
Nucleus observed: proton
Measurement mode: single pulse
Reference peak: TMS

The unit Uᵢₛₒ content (% by mole) derived from isophthalic acid based on all units derived from an acid component was determined by NMR analysis. The total U_{EO} and U_{PO} content (% by mole) based on all units derived from an alcohol component was determined. The U_{EO} content (% by mole) based on the total of the U_{EO} content and the U_{PO} content was then determined.

### Method for Measuring Weight-Average Molecular Weight Mw and Number-Average Molecular Weight Mn

The molecular weight of a specimen, such as the polyester A, the crystalline polyester, or the styrene acryl, is measured by gel permeation chromatography (GPC) as described below.

First, a specimen is dissolved in tetrahydrofuran (THF). The polyester A or styrene acryl is dissolved in THF at room temperature for 24 hours. The crystalline polyester is dissolved in THF heated to 40° C. and is allowed to stand for 24 hours.

A solution of each specimen is passed through a solvent-resistant membrane filter “Myshori Disk” (manufactured by Tosoh Corporation) with a pore size of 0.2 μm to prepare a sample solution. The sample solution is adjusted so that the concentration of a THF-soluble component is 0.8% by mass. The sample solution is subjected to measurement under the following conditions.
Apparatus: HLC8120GPC (detector: RI) (manufactured by Tosoh Corporation)
   Column: Shodex KF-801, 802, 803, 804, 805, 806, and 807 (manufactured by Showa Denko K.K.) in series
Eluent: tetrahydrofuran (THF)
   Flow rate: 1.0 ml/min
   Oven temperature: 40.0° C.
   Sample injection amount: 0.10 ml

The molecular weight of the specimen is calculated from a molecular weight calibration curve, which is prepared using standard polystyrene resins (for example, trade name “TSK standard polystyrene F-850, F-450, F-288, F-128, F-80, F-40, F-20, F-10, F-4, F-2, F-1, A-5000, A-2500, A-1000, and A-500”, manufactured by Tosoh Corporation).

### Method for Measuring Melting Point

The melting point of a crystalline polyester, a release agent, or a plasticizer is measured under the following conditions using a differential scanning calorimeter (DSC) Q2000 (manufactured by TA Instruments).
Heating rate: 10° C./min
Measurement start temperature: 20° C.
Measurement end temperature: 180° C.

The melting points of indium and zinc are used for the temperature correction of a detecting unit of the apparatus, and the heat of fusion of indium is used for calorimetric correction. More specifically, approximately 5 mg of the specimen is precisely weighed, is placed in an aluminum pan, and is measured once. An empty aluminum pan is used as a reference. The peak temperature of the maximum endothermic peak is taken as the melting point.

### Measurement of Glass Transition Temperature Tg

The glass transition temperature Tg is measured with a differential scanning calorimeter “Q2000” (manufactured by TA Instruments)” in accordance with ASTM D3418-82. The melting points of indium and zinc are used for the temperature correction of a detecting unit of the apparatus, and the heat of fusion of indium is used for calorimetric correction. More specifically, approximately 2 mg of the specimen is precisely weighed, is placed in an aluminum pan, and is measured in the measurement temperature range of −10° C. to 200° C. at a heating rate of 10° C./min using an empty aluminum pan as a reference. In the measurement, the temperature is once increased to 200° C., is then decreased to −10° C., and is then increased again. In this second temperature rise process, the specific heat changes in the temperature range of 30° C. to 100° C. The glass transition temperature Tg is an intersection point between a differential heat curve and a line passing through an intermediate point of the baseline before and after the change in specific heat.

### Measurement of Acid Value

The acid value is the number of milligrams of potassium hydroxide required to neutralize an acid contained in 1 g of the specimen.

In the present disclosure, the acid value is measured in accordance with JIS K 0070-1992 and is more specifically measured according to the following procedure.

A 0.1 mol/L potassium hydroxide ethyl alcohol solution (manufactured by Kishida Chemical Co., Ltd.) is used for titration. The factor of the potassium hydroxide ethyl alcohol solution can be determined using a potentiometric titrator (potentiometric titration measuring apparatus AT-510 manufactured by Kyoto Electronics Manufacturing Co., Ltd.) 100 ml of 0.100 mol/L hydrochloric acid is placed in a 250-ml tall beaker and is titrated with the potassium hydroxide ethyl alcohol solution, and the acid value is determined from the amount of the potassium hydroxide ethyl alcohol solution required for neutralization. The 0.100 mol/L hydrochloric acid is prepared in accordance with JIS K 8001-1998.

The measurement conditions for the acid value measurement are as follows:
Titrator: potentiometric titrator AT-510 (manufactured by Kyoto Electronics Manufacturing Co., Ltd.)
Electrode: composite glass electrode double junction type (manufactured by Kyoto Electronics Manufacturing Co., Ltd.)
Control software for titrator: AT-WIN
Titration analysis software: Tview
The titration parameters and control parameters for the titration are as follows:

### Titration Parameters

Titration mode: blank titration
Titration type: total volume titration
Maximum titer: 20 ml
Waiting time before titration: 30 seconds
Titration direction: automatic

### Control Parameters

Endpoint determination potential: 30 dE
Endpoint determination potential values: 50 dE/dmL
Endpoint detection determination: not set
Control speed mode: standard
Gain: 1
Data collection potential: 4 mV
Data collection titer: 0.1 ml
Main test: 0.100 g of a measurement sample is precisely weighed in a 250-ml tall beaker and is dissolved in 150 ml of a toluene/ethanol (3:1) mixed solution for 1 hour. The solution is titrated with the potassium hydroxide ethyl alcohol solution using the potentiometric titrator.
Blank test: titration is performed in the same manner as in the above operation except that the specimen is not used (that is, only the toluene/ethanol (3:1) mixed solution is used). The results are substituted into the following formula to calculate the acid value.

$$A = [ ( C - B ) \times f \times 5.611 ] / S$$

wherein A denotes the acid value (mgKOH/g), B denotes the addition amount (ml) of the potassium hydroxide ethyl alcohol solution in the blank test, C denotes the addition amount (ml) of the potassium hydroxide ethyl alcohol solution in the main test, f denotes the factor of the potassium hydroxide solution, and S denotes the specimen (g).

### Method for Quantifying Aluminum Element in Toner Particles

The fluorescent X-rays of each element are measured in accordance with JIS K 0119-1969, as specifically described below.

The measuring apparatus is a wavelength-dispersive X-ray fluorescence analyzer “Axios” (manufactured by PANalytical) using attached dedicated software “SuperQ ver. 4.0F” (manufactured by PANalytical) for specifying measurement conditions and analyzing measured data. Rh is used as an anode of an X-ray tube, the measurement atmosphere is vacuum, the measurement diameter (collimator mask diameter) is 27 mm, and the measurement time is 10 seconds. A light element is detected with a proportional counter (PC), and a heavy element is detected with a scintillation counter (SC).

Approximately 4 g of toner particles are put into a special-purpose aluminum ring for pressing, are flattened, and are pressed at 20 MPa for 60 seconds using a tablet molding machine “BRE-32” (manufactured by Maekawa Testing Machine Mfg. Co., Ltd.) to form a pellet with a thickness of approximately 2 mm and a diameter of approximately 39 mm as a measurement sample.

The accelerating voltage and the current value of the X-ray generator are measured at 24 kV and 160 mA, respectively, an element is identified based on the peak position of the resulting X-rays, and the concentration thereof is calculated from the counting rate (unit: cps), which is the number of X-ray photons per unit time.

### Method for Measuring Average Circularity of Toner (Particles)

The average circularity of toner or toner particles is measured with a flow particle image analyzer “FPIA-3000” (manufactured by SYSMEX Corporation) under the measurement and analytical conditions for calibration.

After an appropriate amount of alkylbenzene sulfonate surfactant is added as a dispersant to 20 mL of deionized water, 0.02 g of a measurement sample is added and dispersed for 2 minutes using a desktop ultrasonic cleaner/disperser (trade name: VS-150, manufactured by Velvo-Clear) with an oscillation frequency of 50 kHz and an electrical output of 150 watts to prepare a dispersion liquid for measurement. The dispersion liquid is appropriately cooled to a temperature of 10° C. or more and 40° C. or less.

A flow particle image analyzer equipped with a standard objective lens (magnification: 10) is used in the measurement. A particle sheath “PSE-900A” (manufactured by SYSMEX Corporation) is used as a sheath liquid. The dispersion liquid prepared according to the procedure is introduced into a flow particle image analyzer to measure 3000 toner (particles) in an HPF measurement mode and a total count mode, the binarization threshold for particle analysis is set at 85%, the analysis particle size is limited to a circle-equivalent diameter of 1.98 μm or more and 19.92 μm or less, and the average circularity of the toner (particles) is determined.

Before measurement, automatic focus adjustment is performed using standard latex particles (for example, 5100A (trade name) manufactured by Duke Scientific diluted with deionized water). Focusing can be adjusted every 2 hours after the start of measurement.

### Method for Measuring Weight-Average Particle Diameter (D4) of Toner

The weight-average particle diameter (D4) and the number-average particle diameter (D1) of toner were calculated by analyzing measured data, which were measured with a precision particle size distribution analyzer “Coulter Counter Multisizer 3” (registered trademark, manufactured by Beckman Coulter, Inc.) equipped with a 100 μm aperture tube using an aperture impedance method and using associated dedicated software “Beckman Coulter Multisizer 3 Version 3.51” (available from Beckman Coulter, Inc.) for specifying measurement conditions and analyzing measured data. The number of effective measuring channels was 25,000.

An aqueous electrolyte used in the measurement may be approximately 1% by mass special grade sodium chloride dissolved in deionized water, for example, “ISOTON II” (manufactured by Beckman Coulter, Inc.).

Before the measurement and analysis, the dedicated software was set up as described below.

On the “Standard operation mode (SOM) setting screen” of the dedicated software, the total count number in control mode is set at 50,000 particles, the number of measurements is set at 1, and the Kd value is set at a value obtained with “standard particles 10.0 μm” (manufactured by Beckman Coulter, Inc.). A threshold/noise level measurement button is pushed to automatically set the threshold and noise level. The current is set at 1,600 μA, the gain is set at 2, Isoton II is chosen as an electrolyte solution, and flushing of an aperture tube after measurement is checked.

On the “Conversion setting screen of pulse to particle diameter” of the dedicated software, the bin interval is set at the logarithmic particle diameter, the particle diameter bin is set at a 256 particle diameter bin, and the particle diameter range is set at 2 μm to 60 μm.

The specific measurement method is as follows:

1. A 250-mL round-bottom glass beaker specifically for Multisizer 3 is charged with approximately 200 mL of the aqueous electrolyte and is placed on a sample stand. A stirrer rod is rotated counterclockwise at 24 revolutions per second. Soiling and air bubbles in the aperture tube are removed using the “Aperture flushing” function of the analysis software.
2. Approximately 30 mL of the aqueous electrolyte is placed in a 100-mL flat-bottom glass beaker, and approximately 0.3 mL of a dispersant “Contaminon N” (a 10% by mass aqueous neutral detergent for cleaning precision measuring instruments composed of a nonionic surfactant, an anionic surfactant, and an organic builder, pH 7, manufactured by Wako Pure Chemical Industries, Ltd.) diluted 3-fold by mass with deionized water is added to the aqueous electrolyte.
3. A predetermined amount of deionized water is poured into a water tank of an ultrasonic disperser “Ultrasonic Dispersion System Tetora 150” (manufactured by Nikkaki-Bios Co., Ltd.). The ultrasonic disperser includes two oscillators with an oscillation frequency of 50 kHz and has an electrical output of 120 W. The two oscillators have a phase difference of 180 degrees. Approximately 2 mL of Contaminon N is added to the water tank.
4. The beaker of 2. is set in a beaker fixing hole of the ultrasonic disperser, and the ultrasonic disperser is operated. The vertical position of the beaker is adjusted such that the surface resonance of the aqueous electrolyte in the beaker is highest.
5. While the aqueous electrolyte in the beaker of 4. is irradiated with ultrasonic waves, approximately 10 mg of the toner is added little by little to the aqueous electrolyte and is dispersed. The ultrasonic dispersion treatment is continued for another 60 seconds. During the ultrasonic dispersion, the water temperature of the water tank is controlled at 10° C. or more and 40° C. or less.
6. The aqueous electrolyte of 5. in which the toner is dispersed is added dropwise using a pipette to the round-bottom beaker of 1. placed in the sample stand, and the measurement concentration is adjusted to approximately 5%. The measurement is continued until the number of measured particles reaches 50,000.
7. The measured data are analyzed using the dedicated software provided with the apparatus to calculate the weight-average particle diameter (D4) and the number-average particle diameter (D1). When graph/number % and graph/volume % are set in the dedicated software, the “arithmetic diameters” on the analysis/number statistic (arithmetic mean) and analysis/volume statistic (arithmetic mean) screens are the number-average particle diameter (D1) and the weight-average particle diameter (D4).

### Determination of Presence or Absence of Dodecylbenzene Sulfonate in Toner

The presence or absence of dodecylbenzene sulfonate is determined by performing analysis by a MS/MS (mass mass) method with a tandem mass spectrometer directly connected to a liquid chromatograph ESI/MS analyzer.

The MS/MS method is a mass spectrometry method in which a fragment taken out by a first analysis system is measured by a second analysis system, whereby a fragment with a smaller molecular weight can be detected, and structural analysis of a specimen can be easily performed.

Elution conditions A: a toner in methanol (a product corresponding to JIS K 8891) in an amount of 10 times the toner on a mass basis is stirred using an agitator at 25° C. for 10 hours at a rotation speed of 200 rpm.
Centrifugation conditions A: rotation at 25° C., a turning radius of 10.1 cm, and a rotation speed of 3500 rpm for 30 minutes.

The specimen is a toner, is adjusted under the elution conditions A, and is separated into a solid component and a supernatant under the centrifugation conditions A.

The supernatant prepared by the above adjustment is supplied to the following measuring apparatus, and liquid chromatograph ESI/MS analysis is performed under the following analytical conditions B. It is confirmed that a peak at m/z=325 is detected in a mass spectrum of an anion. The ion detected as the peak at m/z=325 is supplied as a precursor ion to the tandem mass spectrometer to acquire a MS/MS spectrum under the analytical conditions B.
Measuring apparatus: Ultimate 3000 (manufactured by Thermo Fisher Scientific)
Mass spectrometer: LCQ Fleet (manufactured by Thermo Fisher Scientific)
Analytical conditions B: Under the following conditions, an ion ionized under the conditions of a capillary voltage of −35 V and a tube lens voltage of −110V is detected as an anion, and an ion detected at m/z=325 is selected as a precursor ion to detect an ion subjected to collision-induced dissociation in an inert gas He at a collision energy of 35 eV.
Ionization method: electrospray method (ESI)
Sheath Gas: 10 (arb. unit.)
Aux Gas: 5 (arb. unit.)
Spray voltage: 5 kV
Capillary temperature: 275° C.
Mobile phase: methanol (a product corresponding to JIS K 8891)
Column: no use (no stationary phase)
Flow rate: 1 ml/min
Injection volume: 10 μl
Chromatogram detector: UV detector
MS acquiring time: 5 min
MS measurement range: 50 to 1500 m/z
Collision inert gas: He (helium)
Collision energy: 35 eV

### Quantitative Determination of Dodecylbenzene Sulfonate in Toner

The quantitative determination of dodecylbenzene sulfonate in the toner is performed by LC/MS measurement of the methanol extract in the toner. A calibration curve is prepared using sodium dodecylbenzene sulfonate as an authentic sample before quantitative determination.

### LC/MS Analytical Conditions

Apparatus: Agilent 6130 Quadropole LC/MS (manufactured by Agilent Technologies)
Eluate: methanol
Column: ZORBAX Eclipse Plus C18 (1.8 μm, 100×4.6 mm I.D.) (manufactured by Agilent Technologies)
Flow rate: 1.0 mL/min
Column temperature: 30° C.

### EXAMPLES

Although the present disclosure is further described in the following exemplary embodiments and comparative examples, the present disclosure is not limited to these exemplary embodiments. Unless otherwise specified, “part” in the exemplary embodiments is based on mass.

### Production Example 1 of Polyester A

2-mole ethylene oxide adduct of bisphenol A: 26 parts by mole
2-mole propylene oxide adduct of bisphenol A: 74 parts by mole
Isophthalic acid: 100 parts by mole

A flask equipped with an agitator, a nitrogen inlet tube, a temperature sensor, and a rectifying column was charged with these monomers and was heated to 190° C. for 1 hour. It was confirmed that the reaction system was uniformly stirred. 1.0 part of tin distearate was added to 100 parts of the monomers. The temperature was increased from 190° C. to 230° C. over 5 hours while produced water was distilled off, and the dehydration condensation reaction was performed at 230° C. for another 1.5 hours.

A polyester A-1 thus produced had a glass transition temperature of 59° C., an acid value of 10.0 mgKOH/g, a hydroxyl value of 24 mgKOH/g, an Mn of 5000, and an Mw/Mn of 3.8.

### Production Examples 2 to 13 of Polyester A

Polyesters A-2 to A-13 were produced in the same manner as in the production example 1 of the polyester A except that the monomers were changed as shown in Table 1 and the reaction temperature and the dehydration condensation time were changed so that the resulting polyester A had desired Mn and Mw/Mn. Table 1 shows the results.

TABLE 1

| | Acid | | | | | | | | | |
|---|---|---|---|---|---|---|---|---|---|---|
| | Isophthalic | Terephthalic | Phthalic | | Alcohol | | | | | |
| Polyester | acid | acid | anhydride | Total | BPA- | BPA- | EG | Total | Physical properties | |
| A | (mol) | (mol) | (mol) | (mol) | EO (mol) | PO (mol) | (mol) | (mol) | Mn | Mw/Mn |
| A-1 | 100 | 0 | 0 | 100 | 26 | 74 | 0 | 100 | 5000 | 3.8 |
| A-2 | 100 | 0 | 0 | 100 | 26 | 74 | 0 | 100 | 8000 | 3.5 |
| A-3 | 100 | 0 | 0 | 100 | 26 | 74 | 0 | 100 | 10000 | 3.2 |
| A-4 | 100 | 0 | 0 | 100 | 26 | 64 | 10 | 100 | 8000 | 4.0 |
| A-5 | 100 | 0 | 0 | 100 | 26 | 59 | 15 | 100 | 3800 | 5.8 |
| A-6 | 95 | 5 | 0 | 100 | 15 | 85 | 0 | 100 | 3300 | 3.5 |
| A-7 | 95 | 5 | 0 | 100 | 40 | 60 | 0 | 100 | 3300 | 3.2 |
| A-8 | 95 | 5 | 0 | 100 | 5 | 95 | 0 | 100 | 3000 | 2.5 |
| A-9 | 95 | 5 | 0 | 100 | 50 | 50 | 0 | 100 | 3000 | 2.5 |
| A-10 | 90 | 10 | 0 | 100 | 26 | 74 | 0 | 100 | 5500 | 3.9 |
| A-11 | 88 | 0 | 12 | 100 | 100 | 0 | 0 | 100 | 8000 | 3.0 |
| A-12 | 0 | 100 | 0 | 100 | 45 | 55 | 0 | 100 | 5000 | 3.5 |
| A-13 | 100 | 0 | 0 | 100 | 55 | 45 | 0 | 100 | 4500 | 3.2 |

BPA-EO: 2-mole ethylene oxide adduct of bisphenol A
BPA-PO: 2-mole propylene oxide adduct of bisphenol A
EG: ethylene glycol

### Production Example of Styrene Acrylic Resin

Styrene: 77 parts
Butyl acrylate: 23 parts
Di-t-butyl peroxide: 1.0 parts

After 200 parts of xylene was heated to 200° C., the above components were added dropwise to the xylene over 4 hours and were held under reflux of xylene for 1 hour to complete polymerization. Table 2 shows the physical properties of the resulting styrene acrylic resin.

TABLE 2

| | Styrene | Butyl acrylate | Mn | Mw/Mn |
|---|---|---|---|---|
| Styrene acrylic resin | 77 | 23 | 12000 | 5.9 |

### Production Example 1 of Crystalline Polyester

In a reaction vessel equipped with a nitrogen inlet tube, a dehydration tube, an agitator, and a thermocouple,
1,10-decanedicarboxylic acid: 100 parts by mole,
1,9-nonanediol: 100 parts by mole, and
Catalyst: 0.8 parts of tin dioctylate based on the total mass of acid alcohol
   were placed in a heated and dried 2-neck flask, nitrogen gas was introduced into the flask to maintain an inert atmosphere, and the temperature was increased while stirring. The product was then stirred at 170° C. for 6 hours. The temperature was then gradually increased to 230° C. under reduced pressure with stirring and was maintained for another 3 hours. When a viscous state was reached, the reaction was stopped by air cooling to produce a crystalline polyester C-1. Table 3 shows the obtained physical properties.

### Production Examples 2 and 3 of Crystalline Polyester

Crystalline polyesters C-2 and C-3 were produced in the same manner as in the production example 1 of the crystalline polyester except that the alcohol monomer and the acid monomer were changed as shown in Table 3. Table 3 shows the physical properties of the crystalline polyesters C-2 and C-3.

TABLE 3

| | | | | Melting | | |
|---|---|---|---|---|---|---|
| Crystalline | | | Acid value | point | | |
| polyester C | Alcohol monomer | Acid monomer | (mgKOH/g) | (° C.) | Mn | Mw/Mn |
| C-1 | 1,9-nonanediol | 1, 12-dodecanedioic acid | 2 | 70 | 11000 | 2.1 |
| C-2 | 1,12-dodecanediol | sebacic acid | 3 | 80 | 10000 | 2.1 |
| C-3 | 1,12-dodecanediol | adipic acid | 4 | 74 | 14000 | 2.3 |

### Production Example of Hydrotalcite Particles 1

An aqueous mixture (liquid A) of 1.03 mol/L magnesium chloride and 0.239 mol/L aluminum sulfate, 0.753 mol/L aqueous sodium carbonate (liquid B), and 3.39 mol/L aqueous sodium hydroxide (liquid C) were prepared.

The liquid A, the liquid B, and the liquid C were poured into a reaction vessel using a metering pump at such a flow rate that the volume ratio liquid A:liquid B was 4.5:1, the pH value of the reaction liquid was maintained in the range of 9.3 to 9.6 with the liquid C, and the reaction temperature was 40° C. to form a precipitate. After filtration and washing, the product was re-emulsified in deionized water to produce a raw material hydrotalcite slurry. The hydrotalcite in the hydrotalcite slurry was 5.6% by mass.

The hydrotalcite slurry was dried under vacuum overnight at 40° C. NaF was dissolved in deionized water at a concentration of 100 mg/L and was adjusted to pH 7.0 with 1 mol/L HCl or 1 mol/L NaOH, and dried hydrotalcite was added thereto at a concentration of 0.1% (w/v %). The product was stirred at a constant speed for 48 hours using a magnetic stirrer so as not to cause sedimentation. The product was then passed through a membrane filter with a pore size of 0.5 μm and was washed with deionized water. The resulting hydrotalcite was dried under vacuum overnight at 40° C. and was then crushed. Table 4 shows the composition and physical properties of the resulting hydrotalcite particles 1.

### Production Examples of Hydrotalcite Particles 2 to 11

Hydrotalcite particles 2 to 11 were produced in the same manner as in the production example of the hydrotalcite particles 1 except that the liquid A:liquid B and the concentration of the aqueous NaF were adjusted as appropriate. Table 4 shows the composition and physical properties of the resulting hydrotalcite particles 2 to 11.

### Production Example of Hydrotalcite Particles 12

Hydrotalcite particles 12 were produced in the same manner as in the production example of the hydrotalcite particles 1 except that deionized water was used instead of the aqueous NaF. Table 4 shows the composition and physical properties of the resulting hydrotalcite particles 12.

TABLE 4

| | Number-average | | |
|---|---|---|---|
| | particle diameter | | |
| | (nm) | Mg/Al | F/Al |
| Hydrotalcite particles 1 | 400 | 2.2 | 0.12 |
| Hydrotalcite particles 2 | 400 | 3.8 | 0.12 |
| Hydrotalcite particles 3 | 400 | 2.1 | 0.32 |
| Hydrotalcite particles 4 | 60 | 3.0 | 0.12 |
| Hydrotalcite particles 5 | 800 | 2.1 | 0.11 |
| Hydrotalcite particles 6 | 1000 | 2.1 | 0.11 |
| Hydrotalcite particles 7 | 1200 | 3.8 | 0.10 |
| Hydrotalcite particles 8 | 400 | 2.1 | 0.01 |
| Hydrotalcite particles 9 | 400 | 2.1 | 0.00 |
| Hydrotalcite particles 10 | 400 | 2.1 | 0.02 |
| Hydrotalcite particles 11 | 400 | 2.1 | 0.60 |
| Hydrotalcite particles 12 | 400 | 2.1 | 0.68 |

### Preparation of Resin Particle Dispersion Liquid of Polyester A-1

Polyester A-1: 100 parts
Methyl ethyl ketone: 50 parts
Isopropyl alcohol: 20 parts

A vessel was charged with the methyl ethyl ketone and the isopropyl alcohol. The polyester A-1 was then gradually charged into the vessel and was completely dissolved while stirring to produce a polyester A-1 solution. The temperature of the vessel containing the polyester A-1 solution was set at 65° C., a total of 5 parts of 10% aqueous ammonia was gradually added dropwise while stirring, and 230 parts of deionized water was gradually added dropwise at 10 ml/min for phase inversion emulsification. Furthermore, the pressure was reduced with an evaporator to remove the solvent and produce a resin particle dispersion liquid of the polyester A-1. Resin particles contained in the resin particle dispersion liquid had a volume-average particle diameter of 130 nm. The resin particle solid content was adjusted to 20% with deionized water.

### Preparation of Resin Particle Dispersion Liquid of Crystalline Polyester C-1

Crystalline polyester C-1: 100 parts
Methyl ethyl ketone: 50 parts
Isopropyl alcohol: 20 parts

A vessel was charged with the methyl ethyl ketone and the isopropyl alcohol. The crystalline polyester C-1 was then gradually charged into the vessel and was completely dissolved while stirring to produce a crystalline polyester C-1 solution. The temperature of the vessel containing the crystalline polyester C-1 solution was set at 40° C., a total of 3.5 parts of 10% aqueous ammonia was gradually added dropwise while stirring, and 230 parts of deionized water was gradually added dropwise at 10 ml/min for phase inversion emulsification. The solvent was then removed under reduced pressure to produce a resin particle dispersion liquid of the crystalline polyester C-1. Resin particles in the resin particle dispersion liquid had a volume-average particle diameter of 150 nm. The resin particle solid content was adjusted to 20% with deionized water.

### Preparation of Colorant Particle Dispersion Liquid

Copper phthalocyanine (Pigment Blue 15:3): 45 parts
Ionic surfactant Neogen RK (sodium dodecylbenzene sulfonate, manufactured by DKS Co. Ltd.): 5 parts
Deionized water: 190 parts

These components were mixed and dispersed for 10 minutes with a homogenizer (Ultra-Turrax manufactured by IKA), and were then dispersed at a pressure of 250 MPa for 20 minutes using Ultimizer (a counter collision type wet mill manufactured by Sugino Machine Ltd.) to produce a colorant particle dispersion liquid with a volume-average particle diameter of 120 nm and a solid content of 20%.

### Preparation of Release Agent Particle Dispersion Liquid

Release agent (hydrocarbon wax, melting point: 79° C.): 15 parts
Ionic surfactant Neogen RK (manufactured by DKS Co. Ltd.): 2 parts
Deionized water: 240 parts

These were well-dispersed at 100° C. with IKA Ultra-Turrax T50 and were dispersed at 115° C. for 1 hour with a pressure ejection type Gaulin homogenizer to produce a release agent particle dispersion liquid with a volume-average particle diameter of 160 nm and a solid content of 20%.

### Production of Toner Particles 1

Resin particle dispersion liquid of polyester A-1: 900 parts
Resin particle dispersion liquid of crystalline polyester C-1: 100 parts
Colorant particle dispersion liquid: 50 parts
Release agent particle dispersion liquid: 80 parts

First, these materials were mixed in a round stainless steel flask. The mixture was then dispersed with a homogenizer Ultra-Turrax T50 (manufactured by IKA) at 5000 r/min for 10 minutes. After the pH was adjusted to 8.0 with 1 mol/L aqueous sodium hydroxide, an aqueous solution of 0.50 parts of aluminum chloride dissolved in 20 parts of deionized water was added as an aggregating agent at 30° C. with stirring over 10 minutes. After standing for 3 minutes, the temperature was increased to 50° C. to produce core particles.

The volume-average particle diameter of the formed agglomerate was appropriately measured with Coulter Multisizer III, and the aggregation step was finished when the agglomerate reached 6.0 μm.

In a subsequent spheronization step, the pH was adjusted to 9.0 with 5% aqueous sodium hydroxide, and the temperature was increased to 92° C. with stirring.

The heating was stopped when a desired surface profile was obtained, ice was quickly put in such a manner that the cooling rate became 10° C./s or more to cool to 40° C. in a cooling step, and an annealing treatment was performed at 55° C. for 3 hours in an annealing step.

This was followed by cooling to 25° C., filtration, solid-liquid separation, and washing with deionized water. The washing was followed by drying with a vacuum dryer to prepare toner particles 1 with a weight-average particle diameter (D4) of 7.0 μm.

### Production Examples of Toner Particles 2 to 10, 12 to 23, and 25 to 27

Toner particles 2 to 12, 14 to 23, and 25 to 27 were produced in the same manner as in the production example of the toner particles 1 except that the blending of the materials to be used and the production conditions were changed so as to satisfy the formulations and physical properties shown in Table 5-1. Table 5 shows physical properties.

### Production Example of Toner Particles 11

### Production of Toner Particles by Pulverization Method

The following materials were well-mixed using an FM mixer (manufactured by Nippon Coke & Engineering Co., Ltd.) and were then melt-kneaded with a twin-screw kneader (manufactured by Ikegai Corporation) set at a temperature of 100° C.
Polyester A-1: 90.0 parts
Crystalline polyester C-1: 10.0 parts
Hydrocarbon wax, melting point 79° C.: 8.0 parts
C.I. Pigment Blue 15:3: 5.0 parts

The kneaded product was cooled and was coarsely ground to 1 mm or less using a hammer mill.

The coarsely ground product was then finely ground to approximately 6.5 μm using a turbo mill manufactured by Turbo Kogyo Co., Ltd., and fine and coarse powders were then removed using a multi-division classifier utilizing the Coanda effect to produce toner particles 11.

The toner particles 11 had a weight-average particle diameter (D4) of 7.0 μm, a Tg of 59° C., and an average circularity of 0.940.

### Production Example of Toner Particles 24

### Production of Toner Particles by Suspension Polymerization Method

### Colorant Dispersion Liquid Preparation Step

Styrene: 68 parts
n-butyl acrylate: 19 parts
C.I. Pigment Blue 15:3: 5.0 parts
Negative charge control agent (aluminum compound of dialkyl salicylic acid): 1 part

These components were dispersed with a medium stirring mill using zirconia beads to prepare a colorant dispersion liquid.

### Polymerizable Monomer Composition Preparation Step

Colorant dispersion liquid: 93.0 parts
Polyester A-1: 3.0 parts
Crystalline polyester C-1: 10.0 parts
Hydrocarbon wax (melting point: 79° C.): 8.0 parts
Negative charge control agent (aluminum compound of dialkyl salicylic acid): 1 part

These components were introduced into a temperature-controllable mixing vessel, were heated to 63° C. while stirring, and were stirred for another 45 minutes to produce a polymerizable monomer composition.

### Aqueous Medium Preparation Step

Water: 97.8 parts
Na₃PO₄: 1.2 parts
10% aqueous hydrochloric acid: 0.3 parts

These components were introduced into another temperature-controllable mixing vessel and were stirred at 60° C. until Na₃PO₄ was completely dissolved.

0.7 parts of CaCl₂ dissolved in 5 parts of water was added thereto and was stirred at 60° C. for 30 minutes using “Clearmix” (manufactured by M Technique Co., Ltd.) at a rotation speed of 50 (l/s) to produce an aqueous suspension of fine Ca₃(PO₄)₂ particles as an aqueous medium.

### Granulation Step

While the aqueous medium was stirred at 60° C. using “Clearmix” (manufactured by M Technique Co., Ltd.) at a rotation speed of 50 (l/s), the polymerizable monomer composition described above was added thereto and was stirred for 3 minutes. 7.0 parts of a polymerization initiator t-butyl peroxypivalate was then added to 100 parts of the polymerizable monomer and was further stirred for 7 minutes to produce a polymerizable monomer composition dispersion liquid.

### Polymerization Step

The polymerizable monomer composition dispersion liquid produced by the above step was introduced into a temperature-controllable mixing vessel and was polymerized at 67° C. for 5 hours and at 80° C. for 4 hours while stirring to produce a fine polymer particle dispersion liquid.

### Volatile Component Removal Step and Cooling Step

The fine polymer particle dispersion liquid produced in the polymerization step was introduced into a mixing vessel that can be heated with steam, was heated to 100° C. by blowing steam from a steam inlet, and was stirred for 5 hours to perform a volatile component removal step.

### Solid-Liquid Separation Step, Washing Step, and Drying Step

Hydrochloric acid was added to the fine polymer particle dispersion liquid and was stirred to dissolve fine Ca₃(PO₄)₂ particles covering the fine polymer particles. The solution was deliquored with a pressure filter, water was added to produce a dispersion liquid again, and the dispersion liquid was deliquored again with a pressure filter for solid-liquid separation. Washing was performed by repeating this operation until Ca₃(PO₄)₂ was sufficiently removed. After the washing, fine polymer particles finally produced by the solid-liquid separation were well dried with a known drying unit to produce toner particles 24.

The particle size of the toner particles 24 was measured, and the toner particles 24 had a weight-average particle diameter (D4) of 7.0 μm and a glass transition temperature Tg of 59° C.

### Production Example of Toner 1

An external additive was added to the toner particles 1. Using an FM mixer (FM10 manufactured by Nippon Coke & Engineering Co., Ltd.), 1.5 parts of silica particles (RX200, primary average particle diameter 12 nm, HMDS-treated, manufactured by Nippon Aerosil Co., Ltd.) and 0.3 parts of the hydrotalcite particles 1 were added to 2.0 kg of the toner particles 1, and external addition was then performed by mixing at 3000 rpm for 5 minutes. At this time, the flow rate and temperature of cold water flowing through the cooling jacket were controlled to adjust the vessel temperature after mixing for 5 minutes to 35° C.

The toner was then sieved through a mesh with a mesh size of 75 μm to produce toner 1. Table 6 shows the physical properties of the toner 1.

### Production Examples of Toners 2 to 43

Toners 2 to 43 were produced in the same manner as in the production example of the toner 1 except that the type of toner particles and the type of hydrotalcite particles were changed as shown in Tables 5-1 and 5-2. Table 6 shows the physical properties of the toners 2 to 43.

TABLE 5-1

| | | Polyester A | | | | | | | | | | |
|---|---|---|---|---|---|---|---|---|---|---|---|---|
| | Toner | | | | | | BPA- | BPA- | | | | |
| Toner | particles | | IPA | TPA | PA | IPA/all | EO | PO | EG | EO or PO/all | U_{EO}/(U_{PO} + U_{EO}) × | Proportion in binder |
| No. | No. | Type | (mol) | (mol) | (mol) | acids | (mol) | (mol) | (mol) | alcohols | 100 | resin (% by mass) |
| 1 | 1 | A-1 | 100 | 0 | 0 | 100 | 26 | 74 | 0 | 100 | 26.0 | 90.0 |
| 2 | 1 | A-1 | 100 | 0 | 0 | 100 | 26 | 74 | 0 | 100 | 26.0 | 90.0 |
| 3 | 1 | A-1 | 100 | 0 | 0 | 100 | 26 | 74 | 0 | 100 | 26.0 | 90.0 |
| 4 | 2 | A-1 | 100 | 0 | 0 | 100 | 26 | 74 | 0 | 100 | 26.0 | 90.0 |
| 5 | 3 | A-1 | 100 | 0 | 0 | 100 | 26 | 74 | 0 | 100 | 26.0 | 90.0 |
| 6 | 4 | A-2 | 100 | 0 | 0 | 100 | 26 | 74 | 0 | 100 | 26.0 | 90.0 |
| 7 | 5 | A-3 | 100 | 0 | 0 | 100 | 26 | 74 | 0 | 100 | 26.0 | 90.0 |
| 8 | 6 | A-4 | 100 | 0 | 0 | 100 | 26 | 64 | 10 | 90 | 28.9 | 90.0 |
| 9 | 7 | A-5 | 100 | 0 | 0 | 100 | 26 | 59 | 15 | 85 | 30.6 | 90.0 |
| 10 | 8 | A-1 | 100 | 0 | 0 | 100 | 26 | 74 | 0 | 100 | 26.0 | 97.0 |
| 11 | 9 | A-1 | 100 | 0 | 0 | 100 | 26 | 74 | 0 | 100 | 26.0 | 85.0 |
| 12 | 10 | A-1 | 100 | 0 | 0 | 100 | 26 | 74 | 0 | 100 | 26.0 | 70.0 |
| 13 | 11 | A-1 | 100 | 0 | 0 | 100 | 26 | 74 | 0 | 100 | 26.0 | 90.0 |
| 14 | 12 | A-6 | 95 | 5 | 0 | 95 | 15 | 85 | 0 | 100 | 15.0 | 90.0 |
| 15 | 13 | A-7 | 95 | 5 | 0 | 95 | 40 | 60 | 0 | 100 | 40.0 | 90.0 |
| 16 | 14 | A-8 | 95 | 5 | 0 | 95 | 5 | 95 | 0 | 100 | 5.0 | 90.0 |
| 17 | 15 | A-9 | 95 | 5 | 0 | 95 | 50 | 50 | 0 | 100 | 50.0 | 90.0 |
| 18 | 16 | A-1 | 100 | 0 | 0 | 100 | 26 | 74 | 0 | 100 | 26.0 | 55.0 |
| 19 | 17 | A-10 | 90 | 10 | 0 | 90 | 26 | 74 | 0 | 100 | 26.0 | 90.0 |
| 20 | 18 | A-1 | 100 | 0 | 0 | 100 | 26 | 74 | 0 | 100 | 26.0 | 65.0 |
| 21 | 19 | A-10 | 90 | 10 | 0 | 90 | 26 | 74 | 0 | 100 | 26.0 | 100.0 |
| 22 | 20 | A-1 | 100 | 0 | 0 | 100 | 26 | 74 | 0 | 100 | 26.0 | 90.0 |
| 23 | 21 | A-1 | 100 | 0 | 0 | 100 | 26 | 74 | 0 | 100 | 26.0 | 90.0 |
| 24 | 22 | A-1 | 100 | 0 | 0 | 100 | 26 | 74 | 0 | 100 | 26.0 | 90.0 |
| 25 | 23 | A-1 | 100 | 0 | 0 | 100 | 26 | 74 | 0 | 100 | 26.0 | 90.0 |
| 26 | 1 | A-1 | 100 | 0 | 0 | 100 | 26 | 74 | 0 | 100 | 26.0 | 90.0 |
| 27 | 1 | A-1 | 100 | 0 | 0 | 100 | 26 | 74 | 0 | 100 | 26.0 | 90.0 |
| 28 | 1 | A-1 | 100 | 0 | 0 | 100 | 26 | 74 | 0 | 100 | 26.0 | 90.0 |
| 29 | 1 | A-1 | 100 | 0 | 0 | 100 | 26 | 74 | 0 | 100 | 26.0 | 90.0 |
| 30 | 1 | A-1 | 100 | 0 | 0 | 100 | 26 | 74 | 0 | 100 | 26.0 | 90.0 |
| 31 | 1 | A-1 | 100 | 0 | 0 | 100 | 26 | 74 | 0 | 100 | 26.0 | 90.0 |
| 32 | 1 | A-1 | 100 | 0 | 0 | 100 | 26 | 74 | 0 | 100 | 26.0 | 90.0 |
| 33 | 1 | A-1 | 100 | 0 | 0 | 100 | 26 | 74 | 0 | 100 | 26.0 | 90.0 |
| 34 | 1 | A-1 | 100 | 0 | 0 | 100 | 26 | 74 | 0 | 100 | 26.0 | 90.0 |
| 35 | 1 | A-1 | 100 | 0 | 0 | 100 | 26 | 74 | 0 | 100 | 26.0 | 90.0 |
| 36 | 1 | A-1 | 100 | 0 | 0 | 100 | 26 | 74 | 0 | 100 | 26.0 | 90.0 |
| 37 | 1 | A-1 | 100 | 0 | 0 | 100 | 26 | 74 | 0 | 100 | 26.0 | 90.0 |
| 38 | 1 | A-1 | 100 | 0 | 0 | 100 | 26 | 74 | 0 | 100 | 26.0 | 90.0 |
| 39 | 1 | A-1 | 100 | 0 | 0 | 100 | 26 | 74 | 0 | 100 | 26.0 | 90.0 |
| 40 | 24 | A-1 | 100 | 0 | 0 | 100 | 26 | 74 | 0 | 100 | 26.0 | 3.0 |
| 41 | 25 | A-11 | 88 | 0 | 12 | 88 | 100 | 0 | 0 | 100 | 100.0 | 100.0 |
| 42 | 26 | A-12 | 0 | 100 | 0 | 0 | 45 | 55 | 0 | 100 | 45.0 | 90.0 |
| 43 | 27 | A-13 | 100 | 0 | 0 | 100 | 55 | 45 | 0 | 100 | 55.0 | 90.0 |

TABLE 5-2

| | | Crystalline polyester C | | Another resin | | Hydrotalcite particles | |
|---|---|---|---|---|---|---|---|
| | Toner | | Proportion in binder | | Proportion in | | Addition amount per 100 parts by |
| Toner | particles | | resin | | binder resin | | mass of toner particles |
| No. | No. | Type | (% by mass) | Type | (% by mass) | Type | (parts by mass) |
| 1 | 1 | C-1 | 10.0 | — | 0.0 | 1 | 0.300 |
| 2 | 1 | C-1 | 10.0 | — | 0.0 | 2 | 0.300 |
| 3 | 1 | C-1 | 10.0 | — | 0.0 | 3 | 0.300 |
| 4 | 2 | C-2 | 10.0 | — | 0.0 | 1 | 0.300 |
| 5 | 3 | C-3 | 10.0 | — | 0.0 | 1 | 0.300 |
| 6 | 4 | C-3 | 10.0 | — | 0.0 | 1 | 0.300 |
| 7 | 5 | C-3 | 10.0 | — | 0.0 | 1 | 0.300 |
| 8 | 6 | C-1 | 10.0 | — | 0.0 | 1 | 0.300 |
| 9 | 7 | C-1 | 10.0 | — | 0.0 | 1 | 0.300 |
| 10 | 8 | C-1 | 3.0 | — | 0.0 | 1 | 0.300 |
| 11 | 9 | C-1 | 15.0 | — | 0.0 | 1 | 0.300 |
| 12 | 10 | C-1 | 10.0 | StAc resin | 20.0 | 1 | 0.300 |
| 13 | 11 | C-1 | 10.0 | — | 0.0 | 1 | 0.300 |
| 14 | 12 | C-1 | 10.0 | — | 0.0 | 1 | 0.300 |
| 15 | 13 | C-1 | 10.0 | — | 0.0 | 1 | 0.300 |
| 16 | 14 | C-1 | 10.0 | — | 0.0 | 1 | 0.300 |
| 17 | 15 | C-1 | 10.0 | — | 0.0 | 1 | 0.300 |
| 18 | 16 | C-1 | 10.0 | StAc resin | 35.0 | 1 | 0.300 |
| 19 | 17 | C-1 | 10.0 | — | 0.0 | 1 | 0.300 |
| 20 | 18 | — | 0.0 | StAc resin | 35.0 | 1 | 0.300 |
| 21 | 19 | — | 0.0 | — | 0.0 | 1 | 0.300 |
| 22 | 20 | C-1 | 10.0 | — | 0.0 | 1 | 0.300 |
| 23 | 21 | C-1 | 10.0 | — | 0.0 | 1 | 0.300 |
| 24 | 22 | C-1 | 10.0 | — | 0.0 | 1 | 0.300 |
| 25 | 23 | C-1 | 10.0 | — | 0.0 | 1 | 0.300 |
| 26 | 1 | C-1 | 10.0 | — | 0.0 | 1 | 0.100 |
| 27 | 1 | C-1 | 10.0 | — | 0.0 | 1 | 0.050 |
| 28 | 1 | C-1 | 10.0 | — | 0.0 | 1 | 0.030 |
| 29 | 1 | C-1 | 10.0 | — | 0.0 | 4 | 0.300 |
| 30 | 1 | C-1 | 10.0 | — | 0.0 | 5 | 0.300 |
| 31 | 1 | C-1 | 10.0 | — | 0.0 | 6 | 0.300 |
| 32 | 1 | C-1 | 10.0 | — | 0.0 | 7 | 0.300 |
| 33 | 1 | C-1 | 10.0 | — | 0.0 | 1 | 0.500 |
| 34 | 1 | C-1 | 10.0 | — | 0.0 | 1 | 0.600 |
| 35 | 1 | C-1 | 10.0 | — | 0.0 | 8 | 0.300 |
| 36 | 1 | C-1 | 10.0 | — | 0.0 | 9 | 0.300 |
| 37 | 1 | C-1 | 10.0 | — | 0.0 | 10 | 0.300 |
| 38 | 1 | C-1 | 10.0 | — | 0.0 | 11 | 0.300 |
| 39 | 1 | C-1 | 10.0 | — | 0.0 | 12 | 0.300 |
| 40 | 24 | C-1 | 10.0 | StAc resin | 87.0 | 1 | 0.030 |
| 41 | 25 | — | 0.0 | — | 0.0 | 9 | 0.800 |
| 42 | 26 | C-1 | 10.0 | — | 0.0 | 1 | 0.030 |
| 43 | 27 | C-1 | 10.0 | — | 0.0 | — | 0.000 |

TABLE 6

| | Polyester A content a | Sodium dodecylbenzene | Aluminum | | Hydrotalcite | | |
|---|---|---|---|---|---|---|---|
| Toner | of binder resin | sulfonate content | content d | Average | content h | | |
| No. | (% by mass) | (ppm) | (% by mass) | circularity | (% by mass) | h/a | h/d |
| 1 | 90.0 | 100 | 0.030 | 0.965 | 0.290 | 0.0032 | 9.7 |
| 2 | 90.0 | 10 | 0.030 | 0.965 | 0.290 | 0.0032 | 9.7 |
| 3 | 90.0 | 1000 | 0.030 | 0.965 | 0.290 | 0.0032 | 9.7 |
| 4 | 90.0 | 100 | 0.030 | 0.975 | 0.290 | 0.0032 | 9.7 |
| 5 | 90.0 | 100 | 0.030 | 0.978 | 0.290 | 0.0032 | 9.7 |
| 6 | 90.0 | 100 | 0.030 | 0.965 | 0.290 | 0.0032 | 9.7 |
| 7 | 90.0 | 100 | 0.030 | 0.965 | 0.290 | 0.0032 | 9.7 |
| 8 | 90.0 | 100 | 0.030 | 0.965 | 0.290 | 0.0032 | 9.7 |
| 9 | 90.0 | 100 | 0.030 | 0.965 | 0.290 | 0.0032 | 9.7 |
| 10 | 97.0 | 100 | 0.030 | 0.965 | 0.290 | 0.0030 | 9.7 |
| 11 | 85.0 | 100 | 0.030 | 0.965 | 0.290 | 0.0034 | 9.7 |
| 12 | 70.0 | 100 | 0.030 | 0.950 | 0.290 | 0.0041 | 9.7 |
| 13 | 90.0 | 0 | 0.000 | 0.940 | 0.290 | 0.0032 | — |
| 14 | 90.0 | 100 | 0.030 | 0.965 | 0.290 | 0.0032 | 9.7 |
| 15 | 90.0 | 100 | 0.030 | 0.965 | 0.290 | 0.0032 | 9.7 |
| 16 | 90.0 | 100 | 0.030 | 0.965 | 0.290 | 0.0032 | 9.7 |
| 17 | 90.0 | 100 | 0.030 | 0.965 | 0.290 | 0.0032 | 9.7 |
| 18 | 55.0 | 100 | 0.030 | 0.965 | 0.290 | 0.0053 | 9.7 |
| 19 | 90.0 | 100 | 0.030 | 0.965 | 0.290 | 0.0032 | 9.7 |
| 20 | 65.0 | 100 | 0.030 | 0.965 | 0.290 | 0.0045 | 9.7 |
| 21 | 100.0 | 100 | 0.030 | 0.965 | 0.290 | 0.0029 | 9.7 |
| 22 | 90.0 | 100 | 0.015 | 0.965 | 0.290 | 0.0032 | 19.3 |
| 23 | 90.0 | 100 | 0.012 | 0.965 | 0.290 | 0.0032 | 24.2 |
| 24 | 90.0 | 100 | 0.150 | 0.965 | 0.290 | 0.0032 | 1.9 |
| 25 | 90.0 | 100 | 0.155 | 0.965 | 0.290 | 0.0032 | 1.9 |
| 26 | 90.0 | 100 | 0.030 | 0.965 | 0.100 | 0.0011 | 3.3 |
| 27 | 90.0 | 100 | 0.030 | 0.965 | 0.050 | 0.0006 | 1.7 |
| 28 | 90.0 | 100 | 0.030 | 0.965 | 0.030 | 0.0003 | 1.0 |
| 29 | 90.0 | 100 | 0.030 | 0.965 | 0.290 | 0.0032 | 9.7 |
| 30 | 90.0 | 100 | 0.030 | 0.965 | 0.290 | 0.0032 | 9.7 |
| 31 | 90.0 | 100 | 0.030 | 0.965 | 0.290 | 0.0032 | 9.7 |
| 32 | 90.0 | 100 | 0.030 | 0.965 | 0.290 | 0.0032 | 9.7 |
| 33 | 90.0 | 100 | 0.030 | 0.965 | 0.490 | 0.0054 | 16.3 |
| 34 | 90.0 | 100 | 0.030 | 0.965 | 0.580 | 0.0064 | 19.3 |
| 35 | 90.0 | 100 | 0.030 | 0.965 | 0.290 | 0.0032 | 9.7 |
| 36 | 90.0 | 100 | 0.030 | 0.965 | 0.290 | 0.0032 | 9.7 |
| 37 | 90.0 | 100 | 0.030 | 0.965 | 0.290 | 0.0032 | 9.7 |
| 38 | 90.0 | 100 | 0.030 | 0.965 | 0.290 | 0.0032 | 9.7 |
| 39 | 90.0 | 100 | 0.030 | 0.965 | 0.290 | 0.0032 | 9.7 |
| 40 | 3.0 | 0 | 0.000 | 0.985 | 0.030 | 0.0100 | — |
| 41 | 100.0 | 0 | 0.000 | 0.965 | 0.780 | 0.0078 | — |
| 42 | 90.0 | 100 | 0.030 | 0.965 | 0.030 | 0.0003 | 1.0 |
| 43 | 90.0 | 0 | 0.030 | 0.965 | 0.000 | 0.0000 | — |

### Image Evaluation

As an image-forming apparatus for evaluating the performance of each toner, HP LaserJet Enterprise Color M555dn, which is a color laser printer equipped with a monocomponent toner contact developing blade cleaning system, and HP212X black toner cartridge (W2120X) CRG, which is a consumable cartridge of the printer, were used after modification.

The main body was modified so that the process speed was 150% and the print test could be performed only at the black station. The cartridge was modified for the evaluation by increasing the volume of the toner container to contain the following amount of toner. This enables durability assessment for a longer lifetime in the main body with a higher speed than before.

### Low-Temperature Fixability in Low-Temperature and Low-Humidity Environment

A solid image (toner load: 0.8 mg/cm²) was continuously printed on three sheets of a transfer material at different fixing temperatures, and the image on the third sheet was evaluated according to the following criteria. In a low-temperature and low-humidity environment (10° C./15% RH), while the temperature was increased in increments of 5° C. in the range of 160° C. to 195° C., a fixed image was taken at each temperature. The fixed image was evaluated for cold offset resistance. The fixing temperature was measured with a non-contact thermometer on the fixing roller surface before paper feeding. The transfer material was letter-size plain paper (XEROX 4200 manufactured by Xerox Corporation, 75 g/m²).

In the fixed image, the cold offset was visually evaluated and was rated according to the following criteria.

### Evaluation Criteria

A: The fixing temperature is less than 180° C.
B: The fixing temperature is 180° C. or more and less than 190° C.
C: The fixing temperature is 190° C. or more and less than 200° C.
D: The fixing temperature is 200° C. or more.

### Evaluation of Low-Temperature Fixability on Rough Paper

NEENAH CLASSIC LAID TEXT (manufactured by Neenah Paper, rough paper with a Bekk smoothness of 5 and a basis weight of 105 g/m²) was used as evaluation paper. The NEENAH CLASSIC LAID TEXT has a smaller Bekk smoothness, which indicates the surface roughness of paper, than commonly used Business 4200 (manufactured by Xerox Corporation, plain paper with a Bekk smoothness of 56 and a basis weight of 105 g/m²) and therefore enables stricter evaluation of a blank area at the time of fixing due to the presence of more recesses in the paper.

The image is a solid image with 80-mm left and right margins and 10-mm top and bottom margins adjusted on evaluation paper. At this time, for a solid black image, the applied voltage is adjusted so that the toner load is 0.8 mg/cm². This adjusted image is visually inspected for the presence or absence of a blank area at each temperature while the set temperature adjustment is changed every 5° C. in the temperature range from 165° C. to 200° C. in a low-temperature and low-humidity environment (10° C./15% RH). A fixed image with no blank area is subjected to a friction resistance test. The friction was performed 5 times with lens-cleaning paper under a load of 4.9 kPa (50 g/cm²). Evaluation was performed according to the following evaluation criteria, and C or higher was determined to be good.

### Evaluation Criteria

A: No blank area at 190° C., and no peeling off even by friction.
B: No blank area at 195° C., and no peeling off even by friction.
C: No blank area at 195° C., but slight peeling off by friction.
D: Blank area even at 195° C.
   Evaluation of Adaptability of Solid Image when Transferred from Normal Temperature and Humidity Environment to Low-Temperature and Low-Humidity Environment

A printer main body and a toner cartridge filled with 550 g of the toner according to the exemplary embodiment were allowed to stand for 24 hours in a normal temperature and humidity environment (25° C./50% RH) for the purpose of adjusting the temperature and humidity in the evaluation environment. After completion of the standing, an image with a printing ratio of 1% was printed out on 5,000 sheets and 10,000 sheets using a horizontal line with a margin of 5 mm, and the sheets were transferred to a low-temperature and low-humidity environment (10° C./15% RH) and were allowed to stand for 6 h. Under the same environment, a solid (toner load: 0.6 mg/cm²) image was printed out on a letter-size XEROX 4200 sheet (manufactured by Xerox Corporation, 75 g/m²) to evaluate the solid image adaptability. In the evaluation of the solid adaptability, a blank area was found in a solid image. Evaluation was performed according to the following evaluation criteria, and C or higher was determined to be good.

### Evaluation Criteria

A: No occurrence.
B: Slight occurrence at an end portion of the third sheet.
C: Occurred on the third sheet.
D: Occurred on the second sheet.
E: Occurred on the first sheet.

### Evaluation of Development Stripe in Low-Temperature and Low-Humidity Environment

A printer main body and a toner cartridge filled with 550 g of the toner according to the exemplary embodiment were allowed to stand for 24 hours in a low-temperature and low-humidity environment (10° C./15% RH) for the purpose of adjusting the temperature and humidity in the evaluation environment. After the standing, in the same low-temperature and low-humidity environment, durability assessment was performed in which a horizontal line image with a printing ratio of 1.0% and a margin of 5 mm was output on 10,000 sheets using letter-size vitality (LTR 75 g/m²) manufactured by Xerox Corporation. A development stripe on a halftone (toner load 0.2 mg/cm²) image and a developing roller was then evaluated. Evaluation was performed according to the following evaluation criteria, and C or higher was determined to be good.

### Evaluation Criteria

A: Two or less development stripes in the circumferential direction are observed on the developing roller. Alternatively, no vertical streak in the paper ejection direction is observed on the image.

B: Three or more and five or less development stripes in the circumferential direction are observed on the developing roller. Alternatively, a vertical streak in the paper ejection direction is slightly observed on the image.

C: 6 or more and 20 or less fine streaks in the circumferential direction are observed on the developing roller. Alternatively, five or less fine vertical streaks in the paper ejection direction are observed on the image.

D: 21 or more streaks in the circumferential direction are observed on the developing roller. Alternatively, a streak of 0.5 mm or more or six or more fine streaks are visually recognized on the image.

Evaluation of Dot Reproducibility of Halftone Image when Transferred from Normal Temperature and Humidity Environment to Low-Temperature and Low-Humidity Environment

A printer main body and a toner cartridge filled with 550 g of the toner according to the exemplary embodiment were allowed to stand for 24 hours in a normal temperature and humidity environment (at a temperature of 25° C./a humidity of 50% RH) for the purpose of adjusting the temperature and humidity in the evaluation environment. After completion of the standing, a test of printing out a horizontal line image with a printing ratio of 1% on 10,000 sheets was performed. It was transferred to a low-temperature and low-humidity environment (10° C./15% RH) and was allowed to stand for 6 hours. In the same environment, a halftone image with a printing ratio of 23% and a margin of 5 mm was output on a letter-size XEROX 4200 sheet (manufactured by Xerox Corporation, 75 g/m²).

Scattering of the toner on the image is a severe evaluation when an image is output from a cooled main body in a low-temperature and low-humidity environment because another member in contact with the toner is hard and the toner is likely to be scattered.

The halftone image was then checked with a magnifier, and the degree of scattering of toner particles was determined to evaluate dot reproducibility. The evaluation was based on the following evaluation criteria.

### Evaluation Criteria

A: The number of dots in which scattering occurs is less than 5%.

B: The number of dots in which scattering occurs is 5% or more and less than 10%.

C: The number of dots in which scattering occurs is 10% or more and less than 15%.

D: The number of dots in which scattering occurs is 15% or more.

### Evaluation of Fogging in Low-Temperature and Low-Humidity Environment

A printer main body and a toner cartridge filled with 550 g of the toner according to the exemplary embodiment were allowed to stand for 24 hours in a low-temperature and low-humidity environment (10° C./15% RH) for the purpose of adjusting the temperature and humidity in the evaluation environment. After the standing, in the same low-temperature and low-humidity environment, durability assessment was performed in which a horizontal line image with a printing ratio of 1.0% and a margin of 5 mm was output on 5,000 or 10,000 sheets using letter-size vitality (LTR 75 g/m²) manufactured by Xerox Corporation.

After standing for one day and after a sheet of paper with a 5 cm×5 cm sticky note attached to the central portion of the printing surface of the paper was set in a cassette, an all-white image was output (all-white image 1).

After the sticky note of the all-white image 1 was peeled off, the reflectivity (%) of a portion to which the sticky note was attached and the reflectivity (%) of a portion to which the sticky note was not attached were measured with a white photometer TC-6DX (manufactured by Tokyo Denshoku Co., Ltd.) to determine the difference between the two portions and calculate the fogging (%). The evaluation was based on the following evaluation criteria.

### Evaluation Criteria

A: The fogging after the durability assessment in the low-temperature and low-humidity environment is less than 0.5.

B: The fogging after the durability assessment in the low-temperature and low-humidity environment is 0.5 or more and less than 1.0.

C: The fogging after the durability assessment in the low-temperature and low-humidity environment is 1.0 or more and less than 1.5.

D: The fogging after the durability assessment in the low-temperature and low-humidity environment is 1.5 or more.

Fogging after Durability and Standing in High-Temperature and High-Humidity Environment

A printer main body and a toner cartridge filled with 550 g of the toner according to the exemplary embodiment were allowed to stand for 24 hours in a high-temperature and high-humidity environment (33° C./85% RH) for the purpose of adjusting the temperature and humidity in the evaluation environment. After the standing, in the same high-temperature and high-humidity environment, durability assessment was performed in which a horizontal line image with a printing ratio of 1.0% and a margin of 5 mm was output on 5,000 sheets using letter-size vitality (LTR 75 g/m²) manufactured by Xerox Corporation.

After standing for five day and after a sheet of paper with a 5 cm×5 cm sticky note attached to the central portion of the printing surface of the paper was set in a cassette, an all-white image was output (all-white image 1).

After the sticky note of the all-white image 1 was peeled off, the reflectivity (%) of a portion to which the sticky note was attached and the reflectivity (%) of a portion to which the sticky note was not attached were measured with a white photometer TC-6DX (manufactured by Tokyo Denshoku Co., Ltd.) to determine the difference between the two portions and calculate the fogging (%). The evaluation was based on the following evaluation criteria.

### Evaluation Criteria

A: The fogging after the durability assessment in the high-temperature and high-humidity environment is less than 0.5.

B: The fogging after the durability assessment in the high-temperature and high-humidity environment is 0.5 or more and less than 1.0.

C: The fogging after the durability assessment in the high-temperature and high-humidity environment is 1.0 or more and less than 1.5.

D: The fogging after the durability assessment in the high-temperature and high-humidity environment is 1.5 or more.

### Fine Line Reproducibility in Low-Temperature and Low-Humidity Environment

Fine line reproducibility was evaluated in a low-temperature and low-humidity environment (10° C./15% RH). After a vertical line image with a printing ratio of 30% was printed out on 3,000 sheets, an image in which a lattice pattern with a line width of 3 pixels was printed on the entire surface of an A4 sheet (print area ratio: 4%) was printed to evaluate fine line reproducibility according to the following evaluation criteria. The line width of 3 pixels is theoretically 127 μm. The line width on the image was measured with a microscope VK-8500 (trade name, manufactured by Keyence Corporation). The line width was measured at five randomly selected points to define the average value d (μm) of three points excluding the minimum value and the maximum value, and the fine line reproducibility index L was calculated and was evaluated according to the following evaluation criteria.

$$L ( μ m ) = \vert 127 - d \vert$$

L defines the difference between the theoretical line width of 127 μm and the line width d on the output image. d may be larger or smaller than 127, and L is therefore defined as the absolute difference. A smaller L indicates higher fine line reproducibility.

### Evaluation Criteria

A: L is 0 μm or more and less than 5 μm.

B: L is 5 μm or more and less than 15 μm, and a slight variation in the width of the fine line is observed.

C: L is 15 μm or more and less than 30 μm, and thinning or scattering of fine lines is observed within the practical use level.

D: L is 30 μm or more, and breakage or thickening of the fine line is observed in places.

### Exemplary Embodiments 1 to 39

In Exemplary Embodiments 1 to 39, the evaluations were performed using the toners 1 to 39. The evaluation results are shown in Tables 7-1 and 7-2. In Table 7, LL denotes the low-temperature and low-humidity environment, NN denotes the normal temperature and humidity environment, and HH denotes the high-temperature and high-humidity environment.

### Comparative Examples 1 to 4

In Comparative Examples 1 to 4, the evaluations were performed using the toners 40 to 43. The evaluation results are shown in Tables 7-1 and 7-2.

TABLE 7-1

| | | | | | | NL → LL adaptability of solid | | | |
|---|---|---|---|---|---|---|---|---|---|
| Exemplary embodiment | Toner | LL | | LL rough paper | | image | | LL development | |
| No. | No. | fixability | | fixability | | 5000 sheets | 10000 sheets | stripe | |
| 1 | 1 | A | 160 | A | 165 | A | A | A | 0 |
| 2 | 2 | A | 160 | A | 165 | A | A | A | 0 |
| 3 | 3 | A | 155 | A | 165 | A | A | A | 0 |
| 4 | 4 | A | 160 | A | 165 | A | A | A | 0 |
| 5 | 5 | A | 160 | A | 165 | A | A | A | 0 |
| 6 | 6 | A | 170 | A | 180 | A | A | A | 0 |
| 7 | 7 | B | 180 | B | 195 | A | A | A | 0 |
| 8 | 8 | A | 175 | B | 195 | A | A | A | 0 |
| 9 | 9 | A | 175 | C | 195 | A | A | A | 0 |
| 10 | 10 | B | 180 | A | 185 | A | A | A | 0 |
| 11 | 11 | A | 155 | A | 160 | A | A | A | 2 |
| 12 | 12 | A | 175 | A | 180 | A | B | B | 3 |
| 13 | 13 | A | 160 | A | 165 | B | C | C | 7 |
| 14 | 14 | A | 160 | A | 165 | A | A | A | 2 |
| 15 | 15 | A | 160 | A | 165 | A | A | A | 2 |
| 16 | 16 | A | 160 | A | 165 | A | A | A | 2 |
| 17 | 17 | A | 160 | A | 165 | A | A | A | 2 |
| 18 | 18 | B | 180 | A | 190 | B | C | A | 1 |
| 19 | 19 | A | 170 | A | 175 | A | B | A | 1 |
| 20 | 20 | B | 185 | A | 190 | B | B | A | 1 |
| 21 | 21 | C | 190 | B | 195 | B | C | A | 1 |
| 22 | 22 | A | 160 | A | 165 | A | B | A | 1 |
| 23 | 23 | A | 160 | A | 165 | B | C | A | 1 |
| 24 | 24 | A | 160 | A | 165 | B | B | A | 1 |
| 25 | 25 | A | 160 | A | 165 | B | C | A | 1 |
| 26 | 26 | A | 160 | A | 165 | A | B | A | 1 |
| 27 | 27 | A | 160 | A | 165 | B | C | A | 1 |
| 28 | 28 | A | 160 | A | 165 | C | C | A | 1 |
| 29 | 29 | A | 160 | A | 165 | A | B | A | 1 |
| 30 | 30 | A | 160 | A | 165 | A | B | A | 1 |
| 31 | 31 | A | 160 | A | 165 | B | B | A | 1 |
| 32 | 32 | A | 160 | A | 170 | C | C | A | 1 |
| 33 | 33 | A | 165 | A | 175 | B | B | A | 1 |
| 34 | 34 | A | 175 | A | 180 | B | C | A | 1 |
| 35 | 35 | A | 175 | A | 185 | B | B | A | 1 |
| 36 | 36 | B | 180 | A | 190 | B | C | A | 1 |
| 37 | 37 | A | 170 | A | 180 | A | B | A | 1 |
| 38 | 38 | A | 155 | A | 160 | A | B | A | 1 |
| 39 | 39 | A | 155 | A | 165 | B | C | A | 1 |
| Comparative example 1 | 40 | C | 190 | C | 195 | D | D | B | 5 |
| Comparative example 2 | 41 | C | 190 | D | 200 | C | D | C | 15 |
| Comparative example 3 | 42 | C | 190 | D | 200 | D | D | C | 10 |
| Comparative example 4 | 43 | B | 180 | C | 195 | D | D | C | 14 |

TABLE 7-2

| | | | | LL fogging | | | | | | |
|---|---|---|---|---|---|---|---|---|---|---|
| | | | | Fogging after | | Fogging after | | HH fogging | | LL fine line |
| Exemplary embodiment | Toner | NN → LL dot | | 5000 sheets | | 10000 sheets | | after durability | | reproducibility after |
| No. | No. | reproducibility | | and standing | | and standing | | and standing | | durability |
| 1 | 1 | A | 1 | A | 0.1 | A | 0.2 | A | 0.1 | A |
| 2 | 2 | A | 1 | A | 0.1 | A | 0.3 | A | 0.1 | B |
| 3 | 3 | A | 1 | A | 0.1 | A | 0.3 | A | 0.1 | A |
| 4 | 4 | B | 8 | A | 0.1 | A | 0.3 | A | 0.2 | A |
| 5 | 5 | C | 10 | A | 0.1 | A | 0.4 | A | 0.2 | A |
| 6 | 6 | A | 3 | A | 0.1 | A | 0.4 | A | 0.2 | A |
| 7 | 7 | A | 3 | A | 0.1 | A | 0.4 | A | 0.1 | A |
| 8 | 8 | A | 3 | A | 0.2 | B | 0.5 | A | 0.2 | A |
| 9 | 9 | A | 3 | A | 0.2 | A | 0.4 | B | 0.6 | A |
| 10 | 10 | A | 3 | A | 0.2 | A | 0.3 | A | 0.3 | A |
| 11 | 11 | A | 3 | B | 0.9 | C | 1.3 | A | 0.3 | A |
| 12 | 12 | A | 3 | A | 0.2 | A | 0.4 | A | 0.3 | B |
| 13 | 13 | C | 10 | B | 0.5 | C | 1.1 | B | 0.7 | C |
| 14 | 14 | A | 3 | B | 0.7 | C | 1.1 | A | 0.3 | A |
| 15 | 15 | A | 2 | B | 0.5 | B | 0.9 | B | 0.8 | A |
| 16 | 16 | A | 2 | B | 0.9 | C | 1.4 | A | 0.3 | A |
| 17 | 17 | A | 2 | B | 0.6 | C | 1.0 | C | 1.2 | A |
| 18 | 18 | A | 3 | A | 0.2 | A | 0.3 | A | 0.2 | A |
| 19 | 19 | A | 2 | A | 0.2 | A | 0.3 | A | 0.2 | A |
| 20 | 20 | A | 2 | A | 0.2 | A | 0.4 | A | 0.2 | A |
| 21 | 21 | A | 2 | A | 0.1 | A | 0.3 | A | 0.2 | A |
| 22 | 22 | B | 7 | A | 0.1 | A | 0.3 | A | 0.2 | A |
| 23 | 23 | C | 11 | A | 0.2 | A | 0.4 | A | 0.2 | A |
| 24 | 24 | B | 8 | A | 0.2 | A | 0.4 | A | 0.2 | A |
| 25 | 25 | C | 10 | A | 0.2 | A | 0.4 | A | 0.2 | A |
| 26 | 26 | A | 4 | A | 0.2 | A | 0.4 | A | 0.2 | A |
| 27 | 27 | B | 7 | A | 0.2 | A | 0.4 | A | 0.2 | A |
| 28 | 28 | C | 11 | A | 0.2 | A | 0.4 | A | 0.2 | A |
| 29 | 29 | A | 2 | A | 0.2 | A | 0.4 | A | 0.2 | A |
| 30 | 30 | A | 3 | A | 0.2 | A | 0.4 | A | 0.2 | A |
| 31 | 31 | A | 3 | A | 0.2 | A | 0.4 | A | 0.2 | A |
| 32 | 32 | A | 4 | A | 0.2 | A | 0.4 | A | 0.2 | A |
| 33 | 33 | A | 3 | A | 0.2 | A | 0.4 | A | 0.2 | A |
| 34 | 34 | A | 4 | A | 0.2 | A | 0.4 | A | 0.2 | A |
| 35 | 35 | A | 3 | B | 0.5 | B | 0.9 | A | 0.2 | A |
| 36 | 36 | A | 3 | B | 0.7 | C | 1.1 | A | 0.2 | A |
| 37 | 37 | A | 3 | A | 0.4 | B | 0.7 | B | 0.6 | A |
| 38 | 38 | A | 3 | A | 0.2 | A | 0.4 | B | 0.7 | A |
| 39 | 39 | A | 3 | B | 0.5 | B | 0.9 | C | 1.0 | A |
| Comparative example 1 | 40 | C | 11 | C | 1.3 | D | 2.1 | C | 1.4 | D |
| Comparative example 2 | 41 | D | 15 | C | 1.3 | D | 2.2 | C | 1.3 | D |
| Comparative example 3 | 42 | C | 11 | C | 1.4 | D | 2.2 | C | 1.4 | C |
| Comparative example 4 | 43 | C | 11 | C | 1.4 | D | 2.4 | D | 1.6 | D |

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-049553 filed Mar. 26, 2024 and No. 2025-033698 filed Mar. 4, 2025, which are hereby incorporated by reference herein in their entirety.

What is claimed is:

1. Toner comprising:
toner particles containing a binder resin; and
an external additive, wherein
1) the binder resin contains a polyester A in an amount of 50% by mass or more, and
the polyester A contains a unit Uᵢₛₒ derived from isophthalic acid in an amount of 90% by mole or more based on all units derived from an acid component, and
2) the toner contains hydrotalcite particles as the external additive.

2. The toner according to claim 1, wherein the polyester A contains a unit U_{EO} derived from an ethylene oxide adduct of bisphenol A and a unit U_{PO} derived from a propylene oxide adduct of bisphenol A, and a total unit U_{EO} and unit U_{PO} content is 90% by mole or more based on all units derived from an alcohol component.

3. The toner according to claim 2, wherein a unit U_{EO} content relative to a sum of the unit U_{EO} content and a unit U_{PO} content is 15% by mole or more and 40% by mole or less.

4. The toner according to claim 1, wherein a tetrahydrofuran (THF) soluble matter of the polyester A has a number-average molecular weight (Mn) of 3,000 or more and 10,000 or less and a ratio (Mw/Mn) of 2.5 or more when the number-average molecular weight (Mn) and a weight-average molecular weight (Mw) are measured by gel permeation chromatography (GPC).

5. The toner according to claim 1, wherein the toner particles contain an aluminum element in an amount of 0.015% by mass or more and 0.150% by mass or less.

6. The toner according to claim 1, wherein the binder resin contains a crystalline polyester.

7. The toner according to claim 1, wherein the toner has an average circularity of 0.950 or more and 0.980 or less.

8. The toner according to claim 1, wherein primary particles of the hydrotalcite particles have a number-average particle diameter of 60 nm or more and 1000 nm or less.

9. The toner according to claim 1, wherein the hydrotalcite particle content is 0.05% by mass or more and 0.50% by mass or less of the toner particles in the toner.

10. The toner according to claim 1, wherein a relationship h/a between a polyester A content a of the binder resin on a mass basis and a hydrotalcite particle content h of the toner on a mass basis is 0.001 or more and 0.006 or less.

11. The toner according to claim 1, wherein, in a line analysis in a scanning transmission electron microscope-energy dispersive spectroscopy (STEM-EDS) mapping analysis of the toner,
fluorine and aluminum are present inside the hydrotalcite particles, and
a ratio F/Al of an atomic number concentration of the fluorine to an atomic number concentration of the aluminum in the hydrotalcite particles, obtained from a principal component mapping of the hydrotalcite particles by the STEM-EDS mapping analysis of the toner, is 0.01 or more and 0.60 or less.
